(19) United States
(12) Patent Application Publication
(10) Pub. No.: US 2026/0300746 A1
(43) Pub. Date: Oct. 1, 2026

(54) SYSTEMS AND METHODS FOR FINE-TUNING OF LARGE LANGUAGE MODELS

(71) Applicant: ACCENTURE GLOBAL SOLUTIONS LIMITED, Dublin 4 (IE)

(72) Inventors: Gyuhak KIM, San Francisco, CA (US); Sumiran Singh THAKUR, San Francisco, CA (US); Su Min PARK, Mountain View, CA (US); Wei WEI, Burlingame, CA (US); Yujia BAO, Mountain View, CA (US)

(73) Assignee: ACCENTURE GLOBAL SOLUTIONS LIMITED, Dublin 4 (IE)

(21) Appl. No.: 19/577,029

(22) Filed: Mar. 24, 2026

Related U.S. Application Data
(60) Provisional application No. 63/778,032, filed on Mar. 26, 2025.

(51) Int. Cl. G06N 3/09

(52) U.S. Cl. CPC G06N 3/09

(57) ABSTRACT

Techniques for fine-tuning of Large Language Models are disclosed. A system receives a pre-trained Large Language Model (LLM) with a set of model parameters from data source. The system also obtains a supervised fine-tuning dataset corresponding to the received pre-trained LLM from the data source. Further, the system selects a grouping strategy for the determined supervised fine-tuning dataset and assigns an importance label to each token in the determined supervised fine-tuning dataset based on the selected grouping strategy. The system further computes a first loss value, a second loss value and a third loss value. The system computes a compute a group-optimization loss value as a weighted combination of the first loss value, the second loss value and the third loss value. Consequently, the system fine-tune the pre-trained LLM by updating the set of model parameters of the pre-trained LLM based on the group optimization loss value.

### CROSS-REFERENCE TO RELATED PATENT APPLICATIONS

This application claims priority to U.S. Provisional Application No. 63/778,032, filed on Mar. 26, 2025, the entire content of which is hereby incorporated by reference in the entirety for all purposes.

### TECHNICAL FIELD

Various examples described herein relate generally to fine-tuning of Large Language Models (LLMs) and, specifically, fine-tuning of the LLMs based on a group optimization loss value using an iterative gradient-based optimization model.

### BACKGROUND

Training or fine-tuning the Artificial Intelligence (AI) or Machine Learning (ML) models (such as Large Language Models (LLMs)) is essential to align with human expectations and specific downstream tasks. The data used for fine-tuning the AI/ML models includes tokens. In AI/ML models, not all tokens contribute equally. Certain words or phrases may be crucial to meaning and performance in language tasks. Identifying the important tokens allows the AI/ML models to focus on the most relevant information.

Traditional systems and methods for fine-tuning the LLMs may treat each training instance (or tokens) of a training data as a uniform sequence, thereby providing equal importance to all tokens regardless of associated relevance. This overlooks the fact that only a subset of tokens contains critical, task-specific information. When evaluating data quality, traditional methods and systems may focus on individual samples at the instance level, overlooking the fact that tokens within a sample do not contribute equally to task-specific semantics. Many tokens primarily serve functional roles (e.g., conjunctions, articles), while a smaller subset carries critical semantic content that directly impacts performance on downstream tasks. While pre-training equips models with a solid foundation for handling function words, fine-tuning may produce diminishing returns if equal emphasis is placed on all tokens rather than prioritizing those that are semantically rich and task-relevant.

Furthermore, in the traditional methods and systems, training loss may be computed as the average cross-entropy loss for next-token prediction across all tokens. Thus, overemphasizing tokens including uninformative words can lead to overfitting, while underfitting on important words hinders the model's ability to capture essential semantic content. The evaluations may compute the overall average loss. There may therefore be a need for techniques for training and/or fine-tuning LLMs more efficiently.

### SUMMARY

Implementations of the present disclosure are generally related to fine-tuning of Large Language Models (LLMs). More particularly, implementations of the present disclosure are directed to fine-tuning of Large Language Models based on a group optimization loss value using an iterative gradient-based optimization model.

In general, aspects of the subject matter described herein provide GenAI based systems and methods for fine-tuning of LLMs based on a group optimization loss value using an iterative gradient-based optimization model, performed by the system. The system may include a hardware processor and non-transitory processor-readable medium storing instructions to be executed by the hardware processor. The non-transitory processor-readable medium may be a memory. The system may receive. The system may receive a pre-trained LLM with a set of model parameters from a data source. The system may determine a supervised fine-tuning dataset corresponding to the received pre-trained LLM from the data source. The supervised fine-tuning dataset may include one or more training samples. Each training sample may include an input sequence and a corresponding output sequence. Herein, each input sequence and the output sequence may include an ordered sequence of tokens. Further, the system may select a grouping strategy for the determined supervised fine-tuning dataset. The grouping strategy may include, but not limited to, a statistics-based grouping strategy, a semantics-based grouping strategy, and a loss-based grouping strategy. Furthermore, the system may assign an importance label to each token in the determined supervised fine-tuning dataset based on the selected grouping strategy. The importance label may include one of an important token label and/or an unimportant token label. Further, the system may compute a first loss value corresponding to an average cross-entropy loss value for the tokens of the supervised fine-tuning dataset using the pre-trained large LLM and based on the assigned importance label. The system may also compute a second loss value and a third loss value corresponding to an average cross-entropy loss value for each of the tokens assigned with the important token label and the tokens assigned with the unimportant token labels using the pre-trained large LLM, respectively. After that, the system may compute a group-optimization loss value as a weighted combination of the first loss value, the second loss value and the third loss value. Consequently, the system may fine-tune the pre-trained LLM by updating the set of model parameters of the pre-trained LLM based on the group optimization loss value using an iterative gradient-based optimization model.

The present disclosure discloses non-transitory computer readable medium including a processor-executable instructions that cause a processor to receive a pre-trained LLM with a set of model parameters from a data source. A supervised fine-tuning dataset may be determined corresponding to the received pre-trained LLM from the data source. The supervised fine-tuning dataset may include one or more training samples. Each training sample may include an input sequence and a corresponding output sequence. Herein, each input sequence and the output sequence may include an ordered sequence of tokens. Further, a grouping strategy may be selected for the determined supervised fine-tuning dataset. The grouping strategy may include, but not limited to, a statistics-based grouping strategy, a semantics-based grouping strategy, and a loss-based grouping strategy. Furthermore, an importance label may be assigned to each token in the determined supervised fine-tuning dataset based on the selected grouping strategy. The importance label may include one of an important token label or an unimportant token label. Further, a first loss value, may be computed, corresponding to an average cross-entropy loss value for the tokens of the supervised fine-tuning dataset using the pre-trained large LLM and based on the assigned importance label. Also, a second loss value and a third loss value, may be computed, corresponding to an average cross-entropy loss value for each of the tokens assigned with the important token label and the tokens assigned with the unimportant token labels using the pre-trained large LLM, respectively. After that, a group-optimization loss value may be computed, as a weighted combination of the first loss value, the second loss value and the third loss value. Consequently, the pre-trained LLM may be fine-tuned by updating the set of model parameters of the pre-trained LLM based on the group optimization loss value using an iterative gradient-based optimization model.

It is appreciated that methods in accordance with the present disclosure can include any combination of the aspects and features described herein. That is, the methods in accordance with the present disclosure are not limited to the combinations of aspects and features specifically described herein, but also include any combination of the provided aspects and features.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment used to execute implementations of the present disclosure.

FIG. 2 illustrates an example architecture of a back-end system for fine-tuning of Large Language Models, in accordance with implementations of the present disclosure.

FIG. 3 illustrates an example block diagram of a training dataset module as shown in FIG. 2, in accordance with implementations of the present disclosure.

FIG. 4 illustrates an example block diagram of a group optimization module, in accordance with implementations of the present disclosure.

FIG. 4A illustrates an example of token importance visualization based on a statistics-based grouping strategy, in accordance with implementations of the present disclosure.

FIG. 4B illustrates an example of token importance visualization based on a semantics-based grouping strategy, in accordance with implementations of the present disclosure.

FIG. 4C illustrates an example of token importance visualization based on a loss-based grouping strategy, in accordance with implementations of the present disclosure.

FIG. 5 illustrates an example block diagram of a loss function module, in accordance with implementations of the present disclosure.

FIG. 6A to 6C illustrates example charts representing the behavior of different training methods, by selecting the statistics-based grouping strategy, the semantics-based grouping strategy, and the loss-based grouping strategy, respectively, in accordance with implementations of the present disclosure.

FIG. 6D illustrates example plots representing average performance different training methods, in accordance with implementations of the present disclosure.

FIG. 7 illustrates an example block diagram illustrating the fine-tuning process of the LLMs, in accordance with implementations of the present disclosure.

FIG. 8 illustrates a flow diagram of an example method for fine-tuning of Large Language Models, executed by the back-end system, in accordance with implementations of the present disclosure.

FIG. 9 illustrates a computer system that may be used to implement the back-end system disclosed in the example environment of FIG. 1 for fine-tuning of Large Language Models, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, “by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

As used throughout this disclosure, the term “important token” refers to a subset of tokens within a sequence which captures the core semantic meaning of the input sequence. Also, the term “unimportant token” refers to a different subset of tokens (rest of the tokens in the sequence, other than “important token”) within the sequence which includes high frequency (stop words), low semantic variance, and minimal impact on the output.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring details of the examples.

The specifications and drawings are to be regarded in an illustrative rather than a restrictive sense. It will, however, be evident that various modifications and changes may be made thereunto without departing from the broader spirit and scope of the invention as set forth in the claims.

There is vast training dataset which may be used for fine-tuning models, such as Large Language Models (LLMs). The training dataset includes tokens, including important and unimportant tokens. The unimportant tokens may be overrepresented in the training dataset. In contrast, important semantic tokens may be rare and underrepresented. This imbalance in token distribution may negatively affect the model's performance on the important tokens. To address aforementioned limitation, the present disclosure may utilize group optimization technique.

The present disclosure discloses systems and methods for fine-tuning of LLMs. The present disclosure may implement effective fine-tuning of the LLMs, with relatively small but carefully curated datasets, thereby underscoring the value of quality over quantity. In other words, fine-tuning with comparatively a smaller number of data samples (for example, only 1,030), but carefully selected examples can produce high-performing instruction-tuned models, thereby emphasizing the importance of identifying key training signals

The systems and methods in the present disclosure may treat groups of tokens differently based on associated importance. The present disclosure may group tokens in each data sample based on the importance values. Further, the present disclosure may optimize the AI/ML model using a mechanism including weighted combination of the group-optimization loss value. The mechanism may adaptively emphasize the most challenging token groups and guide the AI/ML model to manage different group distributions, thereby improving overall learning dynamics for the AI/ML model.

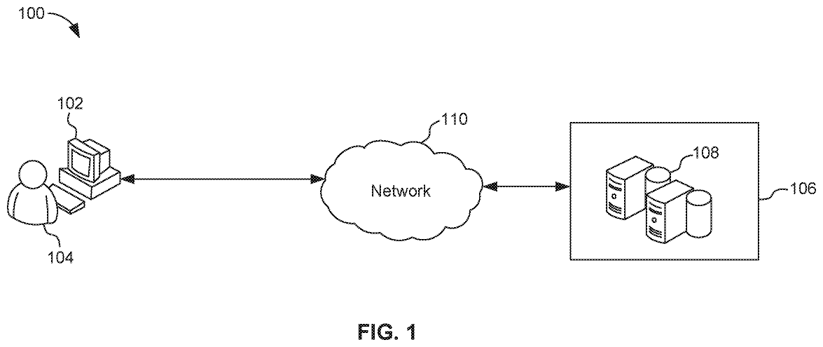

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes a computing device 102, a back-end system 106 and a network 110. In some examples, the computing device 102 are used by respective users 104 to log into and interact with the back-end system 106 and applications executing on the back-end system 106 according to implementations of the present disclosure.

As shown in FIG. 1, the computing devices 102 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites (e.g., web applications executing on the back-end system 106), user devices (e.g., the computing device 102), and the back-end system 106. In some examples, the network 110 can be accessed over a wired and/or a wireless communications link. For example, mobile computing devices, such as smartphones can utilize a cellular network to access the network 110.

While only one back-end system 106 is shown in FIG. 1, there may be more than one back-end system 106, and each of the back-end system 106 includes at least one server system 120. In some examples, the server system 120 hosts one or more computer implemented services that user 104 can interact with by using the computing device 102. For example, components of enterprise systems and applications can be hosted on one or more of the back-end system 106. In some examples, the back-end system 106 can be provided as an on-premises system that is operated by an enterprise or a third-party taking part in cross-platform interactions and data management. In some examples, the back-end system 106 can be provided as an off-premises system (e.g., cloud or on-demand) that is operated by an enterprise or a third party on behalf of an enterprise.

In some examples, the computing device 102 may include computer executable applications executed thereon. In some examples, the computing device 102 may include a web browser application executed thereon, which can be used to display one or more web pages of applications executing on the back-end system 106. In some examples, the computing device 102 can display one or more GUIs that enable the respective user 104 to interact with the back-end system 106. In accordance with implementations of the present disclosure, the back-end system 106 may host enterprise applications or systems that require data sharing and data privacy. In some examples, the computing device 102 can communicate with the back-end system 106 over the network 110.

In some implementations, the back-end system 106 can be implemented in a cloud environment. The back-end system 106 includes at least one server system (or server) 120. In the example of FIG. 1, the back-end system 106 can include various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be used for fine-tuning of the LLMs based on a group optimization loss value using an iterative gradient-based optimization model. Various examples depicting fine-tuning of the LLMs based on a group optimization loss value using an iterative gradient-based optimization model are described in detail in conjunctions with figures below.

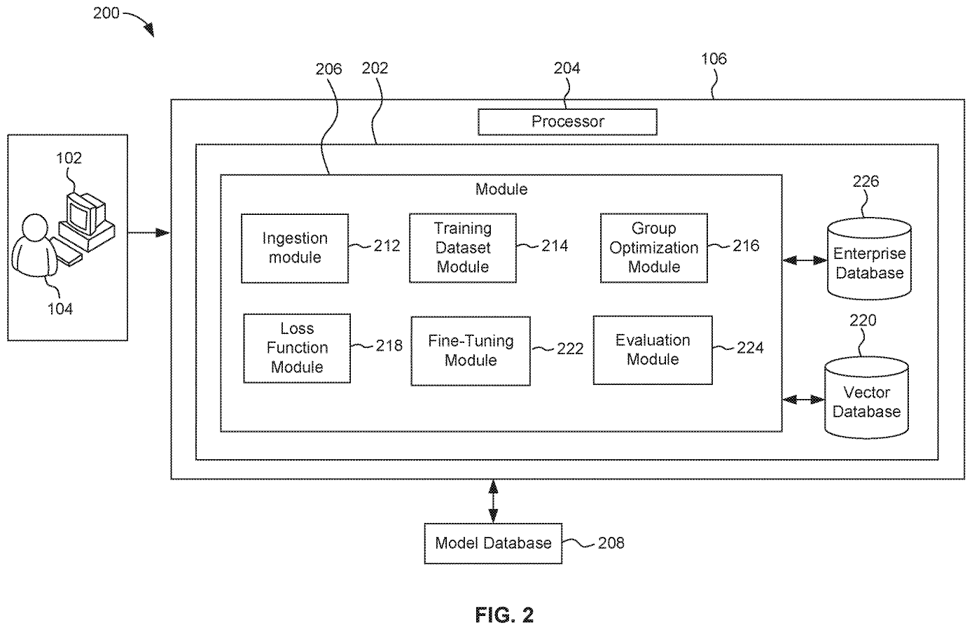

FIG. 2 illustrates an example architecture 200 of the back-end system 106 for fine-tuning of Large Language Models (LLMs), in accordance with implementations of the present disclosure. The back-end system 106 may include one or more non-transitory processor-readable medium (herein referenced as memory) 202 storing processor-executable instructions to be executed by the one or more hardware processors 204. In the back-end system 106, the one or more hardware processors 204 may be communicably coupled with the one or more memory 202 and configured to execute the processor-executable instructions. In some examples, the one or more hardware processors 204 may include, but not limited to, microprocessors, microcomputers, hardware processors, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the one or more hardware processors 204 may be programmed to cooperate with non-transitory processor-readable instructions stored in one or more memory 202 for performing operations according to the present disclosure. The one or more memory 202 may be non-transitory or non-volatile medium, such as a magnetic disk or solid-state non-volatile memory or volatile medium such as Random Access Memory (RAM), and/or the like.

In some examples, the one or more memory 202 may include an enterprise database 220, and modules 206. The modules 206 may be in the form of programmable instructions executable by the one or more hardware processors 204. Further, the back-end system 106 may be communicatively coupled to a model database 208. The model database 208 may include one or more Large Language Models (LLMs) (also be referenced to as GenAI models, foundation models, natural language processing (NLP) model, deep learning model, Graph neural network (GNN), Vision-Language Model (VLM) and/or the like). In an implementation, the LLMs may include pre-trained LLMs or generated LLMs. The pre-trained LLMs may be general-purpose generative Artificial Intelligence (GAI) models like large deep learning neural networks, which may be trained using a broad range of generalized and unlabelled training data to perform one or more tasks, such as, human computer interactions (i.e., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or Artificial Intelligence (AI) models.

Further, the modules 206 may include an ingestion module 212, a training dataset module 214, a group optimization module 216 and a loss function module. The ingestion module 212 may receive a pre-trained Large Language Model (LLM) with a set of model parameters from the model database 208 (also referenced as a data source) . . . . Herein, the set of model parameters may include, but not limited to, weights, biases, embedding parameters, attention parameters, feedforward network parameters, number of layers, dimensions, attention heads and temperature.

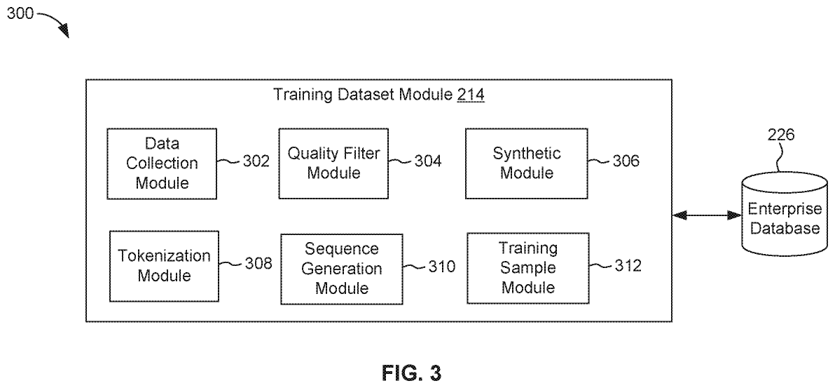

The training dataset module 214 may obtain a supervised fine-tuning dataset corresponding to the received pre-trained LLM. The supervised fine-tuning dataset may refer to collection of labeled, task-specific examples used to further train the pre-trained LLM. The supervised fine-tuning dataset including the labeled data, may be used further to specialize (or fine-tune) the pre-trained LLM for specific tasks, such as instruction following, classification, or conversational, improving performance, accuracy, and behavior. Herein, the supervised fine-tuning dataset may include one or more training samples. Each training sample may include an input sequence and a corresponding output sequence. Each of the input sequence and the output sequence may include an ordered sequence of tokens. Tokens may refer to data units (such as, words, sub-words, characters, parts of images or the like), which the pre-trained LLM may use to process and understand information included in the supervised training dataset. The tokens may include functional words or stylistic elements (which form the basic structure of language) may appear frequently and may be overrepresented in the supervised training dataset. The training dataset module 214 is described in detail in conjunction with FIG. 3.

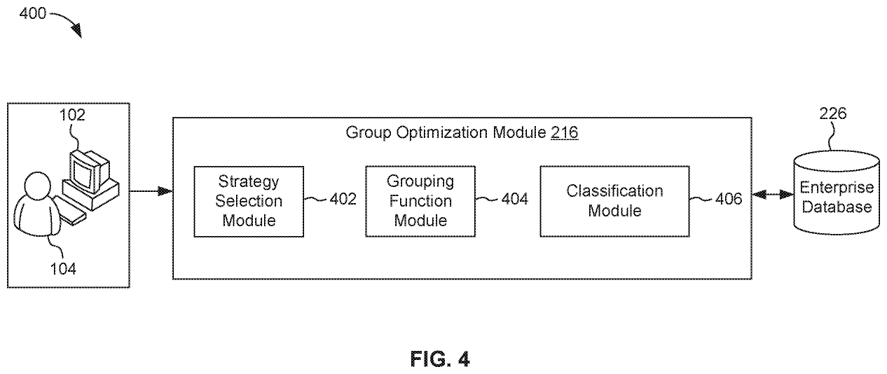

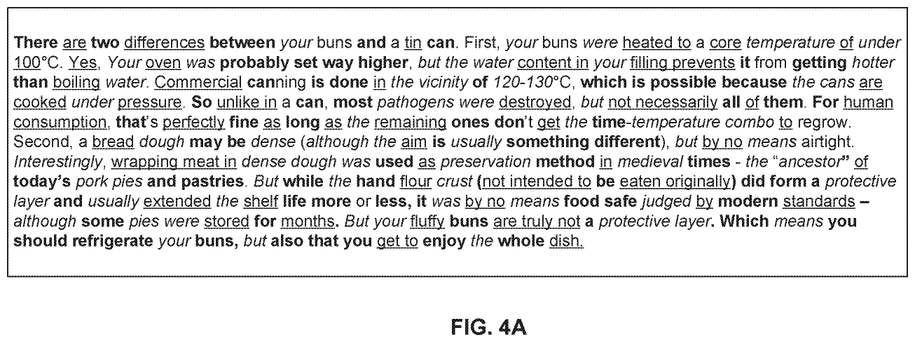

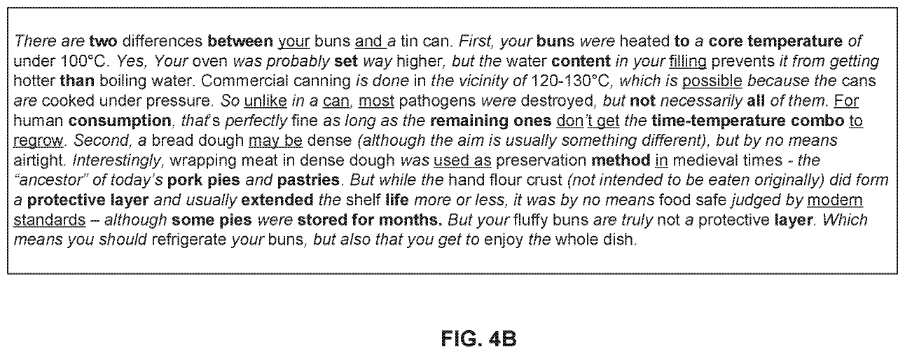

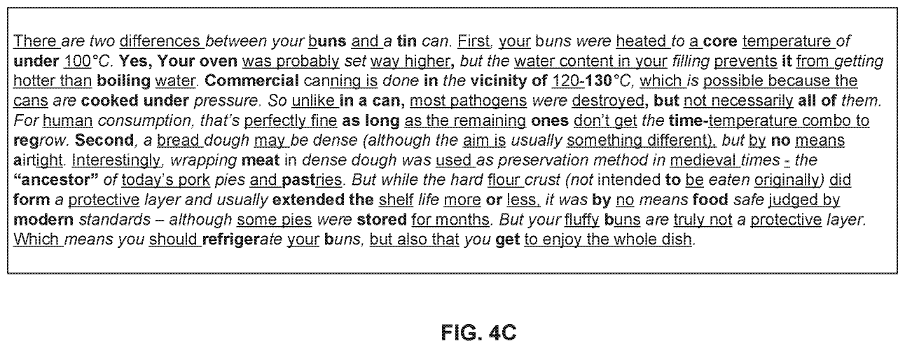

The determined supervised fine-tuning dataset may be further processed by the group optimization module 216. The group optimization module 216 may determine a grouping function to select a grouping strategy for the determined supervised fine-tuning dataset. The grouping strategy may include, but not limited to, a statistics-based grouping strategy, a semantics-based grouping strategy, and a loss-based grouping strategy. The grouping function may refer to a discrete mapping logic which partitions the tokens of the sequence into specific subsets based on associated semantic, statistical, or optimization-driven characteristics. Furthermore, based on the determined grouping function, using the selected grouping strategy, the group optimization module 216, may assign an importance label to each token in the determined supervised fine-tuning dataset. Herein, the importance label may include, but not limited to, an important token label and an unimportant token label. In other words, the group optimization module 216 may classify the tokens in the determined supervised fine-tuning dataset into, but not limited to, an important token group and an unimportant token group. The group optimization module 216 is described in detail in conjunction with FIG. 4.

After, assignment of the importance label to each token in the determined supervised fine-tuning dataset, the loss function module 218 may compute a group-optimization loss value of the tokens in supervised fine-tuning dataset. In further detail, the loss function module 218 may compute a first loss value, a second loss value and a third loss value, based on the assigned importance label. After that, the loss function module 218 may compute a weighted combination of the first loss value, the second loss value and the third loss value. The resulting value of the weighted combination may be the group-optimization loss value.

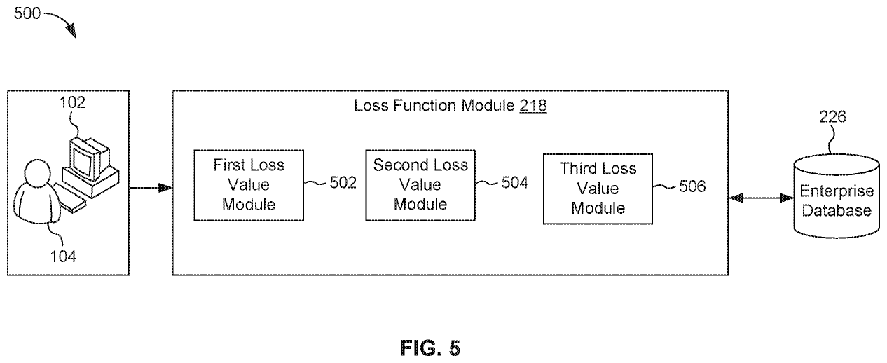

The loss function module 218 may compute the first loss value, the second loss value and the third loss value, by using the pre-trained LLM. Herein, the first loss value may correspond to an average cross-entropy loss value for the tokens of the supervised fine-tuning dataset. The second loss value may correspond to an average cross-entropy loss value for each of the tokens assigned with the important token label. Moreover, the third loss value may correspond to an average cross-entropy loss value for each of the tokens assigned with the unimportant token label. The loss function module 218, thereafter, may compute the group-optimization loss value as a weighted combination of the first loss value, the second loss value and the third loss value. The loss function module 218 is described in detail in conjunction with FIG. 5.

Consequently, the fine-tuning module 222 may fine-tune the pre-trained LLM by updating the set of model parameters of the pre-trained LLM based on the group optimization loss value using an iterative gradient-based optimization model. In further detail, the fine-tuning module 222 may determine trajectories of the first loss value, the second loss value, and the third loss value as functions of a training iteration index for each of the statistics-based grouping strategy, the semantics-based grouping strategy, and the loss-based grouping strategy during the training iterations. Herein, said trajectories may refer to the sequence of loss values over each iteration. In further detail, the trajectories may represent chronological learning curves which may log the numerical error for each token at every discrete step of the fine-tuning process. By treating the chronological learning curves as time-series data, the fine-tuning module 222 may visualize evolution of the pre-trained LLM's performance on critical versus non-critical data over the entire fine-tuning timeline.

Moreover, the fine-tuning module 222 may map the determined trajectories as time series data for each grouping strategy. The time series data may indicate a behavior of the cross-entropy loss value for the tokens assigned with the important token label, and the tokens assigned with the unimportant token label. By mapping the trajectories, the fine-tuning module 222 may determine if the gap between second loss value and the third loss value is narrowing or diverging over time.

Further, the fine-tuning module 222 may compute one or more gradients for the group-optimization loss value based on the set of model parameters of the pre-trained LLM using a backpropagation network with subsequent-token predictions. The one or more the gradients for the group-optimization loss value may refer to the vector representation of partial derivatives which may specify how the pre-trained LLM may adjust the parameters to reduce the total error across specific token groups (the important token group and the unimportant token group). After that, the fine-tuning module 222 may update the set of model parameters of the pre-trained LLM based on the computed gradients and the mapped time series data. The fine-tuning module 222 may apply the iterative gradient-based optimization model, with a learning rate, a cosine decay learning rate schedule, and an epsilon parameter, for training iterations until a termination condition is satisfied. The iterative gradient-based optimization model may compute the gradient (slope) of the loss value with respect to the parameters (that is, the learning rate, the cosine decay learning rate schedule, and the epsilon parameter) and update the weights in the opposite direction of the gradient to minimize the error. The learning rate may control the size of the steps taken toward the minimum. For instance, a high learning rate may overshoot, while a low learning rate may take comparatively long to converge. The epsilon parameter may refer to a very small constant (for example, 10⁻⁷ to 10⁻⁸) added to the denominator in to prevent division by zero when the gradient history is zero. The cosine decay learning rate schedule may refer to a learning rate schedule which may reduce the learning rate, following a cosine curve, starting from an initial value, down to a minimum value, over a specified number of steps. Furthermore, the termination condition may refer to the scenario when training process of the pre-trained LLM stop when a condition is met, such as reaching a maximum number of epochs/steps, or when the loss stabilizes (converges) and improvement becomes negligible.

In an aspect, the evaluation module 224 may evaluate the performance of the fine-tuned LLM. The evaluation module 224 may evaluate the performance of the fine-tuned LLM based on, but not limited to, a first subset of criteria and a second subset of criteria. The first subset of criteria may include subject-specific criteria. The subject-specific criteria may include one or more benchmarks evaluating subject-specific accuracy and the density of specialized latent knowledge within the parameters of the fine-tuned LLM. The non-limiting examples of the subject-specific criteria may include Massive Multitask Language Understanding (MMLU), MathQA, AI2 Reasoning Challenge (ARC-C) and OpenBookQA. MMLU may be used to evaluate the capabilities of Large Language Models (LLMs) across 57 subjects. The MMLU may evaluate the fine-tuned LLM's using few-shot (for example, (0-shot and 5-shot) settings (providing examples in the prompt) to assess generalization. The MatheQA (for example 0-shot) may include math word problems that require the extraction of key information from natural language narratives and the conversion of the narratives into executable meaning representations. The ARC-C may test the multi-step reasoning of the fine-tuned LLM via science questions which may be unable to be solved with only retrieval. The OpenBookQA may evaluate the fine-tuned LLM's ability to combine a fact with reasoning to answer science questions.

Moreover, the second subset of criteria may include general reasoning criteria. The general reasoning criteria may include one or more benchmarks evaluating the fine-tuned LLM's capacity for logical inference, common sense, and/or multi-step problem solving. The non-limiting examples of the general reasoning criteria may include Harder Endings, Longer contexts, and Low-shot Activities for Situations with Adversarial Generations (HellaSwag), Truthful Question Answering (TruthfulQA) and Instruction-Following Evaluation (IFEval). The HellaSwag may be used to tests on broad knowledge and reasoning in 57 diverse subjects. In other words, the HellaSwag may be used to test the capability of the fine-tuned LLM for predicting the most plausible next sentence in a real-world, physical scenario. The TruthfulQA may be used to assess the fine-tune LLM's capability to provide factually accurate answers, even when questions are designed to elicit common misconceptions or falsehoods. The IFEval may be used to evaluate the fine-tuned LLM's natural language instruction following ability. In other words, the IFEval may be used to evaluate the capability of the fine-tuned LLM, adhering to specific, verifiable prompts or instructions, such as adhering to formatting constraints (for example, “start with a keyword”, “write >400 words”, or the like).

The evaluation module 224 may assign scores to the fine-tuned LLM based on one or more test prompts and responses. The evaluation module 224 may assign scores by applying the subject-specific criteria and the general reasoning criteria to the one or more test prompts and responses. Further, the evaluation module 224 may first normalize assigned scores into a numerical interval (for example [0,1]), by utilizing techniques such as Z-score normalization.

Consequently, the evaluation module 224 may compute a first average score for the subject-specific criteria and a second average score for the general reasoning criteria. Once the first average score and the second average score are computed, the evaluation module 224 may perform a comparative analysis to evaluate the fine-tuned LLM.

FIG. 3 illustrates an example block diagram 300 of the training dataset module 214 to determine the supervised fine-tuning dataset corresponding to the received pre-trained LLM, in accordance with implementations of the present disclosure. The training dataset module 214 may further include a data collection module 302, a quality filter module 304, a synthetic module 306, a tokenization module 308, a sequence generation module 310 and a training sample module 312. In some examples, the training dataset module 214 may be communicatively coupled to the enterprise database 220. The enterprise database 220 may be used to store various data and intermediate results generated by the data collection module 302, the quality filter module 304, the synthetic module 306, the tokenization module 308, the sequence generation module 310 and the training sample module 312 of the training dataset module 214.

In some examples, the enterprise database 220 may include, but not limited to, a community data source and a synthetic data source. The community data source may include authentic, human-generated text collected from various, such as, open-source or community-driven platforms. The community data source may include data collected from forums, public repositories, or domain-specific question-answer (Q&A) sites, reflecting natural human language, diverse perspectives, and real-world scenarios. Further, the synthetic data source may include data generated by, or in conjunction with, another AI model to mimic real-world data characteristics. For example, the synthetic data source may include prompt-response pairs generated by AI/ML model. The data collection module 302 may receive candidate prompt-response pairs from the community data source and/or the synthetic data source. Herein, the prompt-response pairs may refer to the discrete unit of supervised data used to align the LLM via instruction tuning. The prompt-response pair may represent mapping between an input stimulus and a target ground-truth output from the pre-trained LLM.

The received prompt-response pairs may be further processed by the quality filter module 304. The quality filter module 304 may generate a subset of quality prompt-response pairs by filtering the received prompt-response pairs based on a quality criteria. The subset of the quality prompt-response pairs may include a subset of community-sourced pairs and a subset of user defined pairs. In some examples, the quality filter module 304 may determine the quality criteria by utilizing techniques such as, using heuristic filters, model-based scoring and deduplication. By using the heuristic filters, the quality filter module 304 may remove the prompt-response pairs which may include, for example, repetitive phrases, or exceeds/are below pre-defined threshold length. The model-based scoring may include utilizing AI/ML models, such as reward model, classifier (such as, Robustly Optimized BERT Pretraining Approach (ROBERTa)-based evaluator) model to assign a quality score to each prompt-response pair. The quality filter module 304 may filter the prompt-response pairs exceeding a specific threshold (for example, quality score >0.8), as the subset of the quality prompt-response pair. Also, the quality filter module 304 may utilize techniques, such as, MinHash or locality sensitive hashing (LSH) to remove semantically identical prompt-response pairs from the received prompt-response pairs.

Additionally, or alternatively, the received prompt-response pairs may be processed by the synthetic module 306. The synthetic module 306 may generate a subset of instruction-response pairs using the one or more LLMs (from the model database 208) based on template prompts and task descriptions. The subset of the instruction-response pairs may include synthetic data samples and raw data samples. The synthetic module 306 may first define a schema. The schema may refer to high-level definitions of the tasks performed by the pre-trained LLMs (for example, “python debugging”, “entity extraction”, “creative writing”, or the like). The synthetic module 306 may further utilize structured meta-prompts to query the one or more LLMs. The synthetic module 306 may input the schema and the structured meta-prompts to the one or more LLMs. In response to the input, the one or more LLMs may perform inference to generate the subset of the instruction-response pairs.

The generated subset of quality prompt-response pairs and subset of instruction-response pairs may be further processed by the tokenization module 308. In further detail, the tokenization module 308 may generate a tokenized representation of the candidate prompt-response pairs. The tokenization module 308 may normalize a corresponding input sequence and a corresponding output sequence for each prompt-response pair in the subset of the quality prompt-response pairs and the subset of the instruction-response pairs. The tokenization module 308 may perform normalization by removing erratic whitespace, standardizing unicode, or the like. The tokenization module 308 may also utilize embedding models (such as bidirectional encoder representations from transformers (BERT), Word2vec, or the like) to generate the tokenized representation. Furthermore, the sequence generation module 310 may generate the corresponding output sequence as the ordered sequence of the tokens based on the generated tokenized representation. In some examples, the generated tokenized representation may be a sequence of integers (for example, [5001, 40, 78, 312]) which the pre-trained LLM is capable of processing. For instance, an “end of text” token may be appended to the output sequence to train the one or more LLMs regarding stop generation of further training samples. Subsequently, the training sample module 312 may generate the training samples by assigning the corresponding ordered sequence of the tokens as a training target. After that, training sample module 312 may aggregate the training samples from the subset of prompt-response pair and the subset of instruction-response pairs, into the supervised fine-tuning dataset. Each training sample may include the input sequence and the corresponding output sequence with the ordered sequence of tokens.

In an aspect, each training sample may include a corpus of N sentences or documents, may be denoted as:

$$S = {s}^{( 1 )} , {s}^{( 2 )} , … , {s}^{( N )}$$

Each sentence s⁽ⁱ⁾ may include a sequence of tokens expressed as below:

$${s}^{( i )} = [ {w}^{( i , 1 )} , {w}^{( i , 2 )} , … , {w}^{( i , {L}_{i} )} ]$$

wherein, Lᵢ may denote the number of tokens in the i^{th} sentence.

FIG. 4 illustrates an example block diagram 400 of the group optimization module 216 to select a grouping strategy for the determined supervised fine-tuning dataset, in accordance with implementations of the present disclosure. The group optimization module 216 may further include a strategy selection module 402, a grouping function module 404 and a classification module 406. In some examples, the group optimization module 216 may be communicatively coupled to the enterprise database 220. The enterprise database 220 may be used to store various data and intermediate results generated by the strategy selection module 402, the grouping function module 404 and the classification module 406, of the group optimization module 216.

The strategy selection module 402 may receive a user input for the determined supervised fine-tuning dataset from the user 104. In an aspect, the user input (also called as the user query) may be a natural language query, which may further include, but not limited to, a workflow request, and an action command. The natural language query may refer to a free-form textual input expressed in user language, intended for information retrieval or a factual answer concerning the enterprise data. The workflow request may refer to an instruction initiating a defined, multi-step process or sequence of operations within the enterprise environment (for example, initiating a multi-stage approval process). The action command may refer to a direct, imperative instruction intended to trigger a specific, singular operation or modification within the back-end system 106 or on the enterprise data (for example, “update record X”, “create report Y”, or the like). It may be appreciated that the user 104 is shown for illustration purposes only and that ‘user’ generating user queries (request) in accordance with the disclosed examples can also include applications being executed on the computing device 102 that automatically generate the natural language user queries without intervention from the human user 104. The user query may be a string of text formulated by the user 104 to express the required information. For instance, the user query may range from simple keyword searches phrased in a conversational manner (for example, “What is the capital of France?”) to complex, multi-clause questions requiring nuanced understanding of context and semantics (for example, “What are the long-term effects of this medication, considering the patient's history of heart disease?”). In addition to text initiated by the user 104, the user query may be implicitly generated from system events or derived from diverse data sources, encompassing textual input, uploaded files, documents, and multimedia content.

The strategy selection module 402 may implement the statistics-based grouping strategy, by using a statistics-based model. In further detail, the strategy selection module 402 may precompute unigram term-frequency-inverse-document-frequency (TF-IDF) scores for the tokens in the supervised fine-tuning dataset. The strategy selection module 402 may compute the TF-IDF scores by multiplying a token's frequency within a document, by corresponding inverse document frequency, across a corpus. In other words, the TF-IDF scores may identify words which are frequent in a specific document but rare across the entire collection. The higher TF-IDF scores may indicate higher relevance. The TF-IDF scores may indicate a rarity level of each token corresponding to the supervised fine-tuning dataset. In some examples, the strategy selection module 402 may determine “n” number of highest-weighted terms (n tokens with highest TF-IDF scores in the supervised fine-tuning dataset), which may measure the importance of a word with respect to a specific document within a larger collection. Based on TF-IDF scores, the classification module 406 may group the tokens with the top “n” TF-IDF scores as important tokens, leaving the rest as unimportant tokens, in the further steps.

In further detail, the TF-IDF scores used by the strategy selection module 402, may be based on statistical frequency, thereby, striking a balance between the frequency within the given corpus and the rarity. The strategy selection module 402, by implementing the statistics-based grouping strategy may be independent of semantic context or model-based representations, thereby leading to a prioritization scheme which may be lexically, rather than semantically or syntactically, driven. In an example representation, FIG. 4A may indicate a token importance visualization based on the TF-IDF scores, which may highlight rare terms without considering context or syntactic structure. For example, as shown in FIG. 4A, tokens such as “human”, “stored” and “not intended” may receive the highest weight, yet function words and syntactic markers such as “but”, “and”, and “the” may comprise the majority. The strategy selection module 402 may overemphasize conjunction words regardless of the actual semantic contribution, thereby amplifying domain specific jargon while failing to distinguish between informative and infrequent terms. The strategy selection module 402 may implement the statistics-based grouping strategy for retrieval-based tasks such as keyword extraction.

Moreover, the strategy selection module 402 may implement the semantics-based grouping strategy. In further detail, to implement the semantics-based grouping strategy, the strategy selection module 402 may utilize contextual semantics to determine the importance of each token in the supervised training dataset. For instance, strategy selection module 402 may utilize a prompt compression method to determine the importance of the tokens. In some examples, strategy selection module 402 may utilize the prompt compression method by using a pre-trained compression model, from the model database 208. In some examples, the pre-trained compression model may be semantic-based model, such as BERT-based encoder-only transformer model. The prompt compression method may refer to a technique used in natural language processing (NLP), to reduce the length and complexity of the input sequence, by removing redundant or unimportant tokens while retaining essential information. The strategy selection module 402, by using the pre-trained compression model, may generate a preservation probability score for each token in the supervised fine-tuning dataset by encoding the ordered sequence of the tokens in the input sequence. Herein, the preservation probability score may indicate a decision of retaining the token in a compressed representation of the input sequence.

In some examples, the strategy selection module 402, may implement the semantics-based grouping strategy, by utilizing the open-source prompt compression LLMs. The strategy selection module 402, by utilizing the open-source prompt compression LLMs, may assign the token importance based on token probability, where words with lower predictive confidence are deemed informative. In further detail, the strategy selection module 402 may calculate perplexity of the sequence. The strategy selection module 402, by using the calculated perplexity, may identify tokens whose removal may cause a sharp spike in perplexity, said tokens may be further labelled as important tokens. The probabilistic approach may inherently align with syntactic structure and textual coherence, as uncertainty often arises at transitional points in a sentence or phrase. Consequently, as shown in FIG. 4B, connective elements such as “but,” “although,” and “as long as” may receive higher importance, suggesting that open-source prompt compression LLMs emphasizes tokens which mediate sentence flow and grammatical dependencies. The strategy selection module 402, by using the open-source prompt compression LLMs may identify words which govern linguistic cohesion and sentence progression, ensuring that the fine-tuned LLM predicts discourse-level fluency rather than merely content-bearing terms.

Additionally, or alternatively, the strategy selection module 402 may implement the loss-based grouping strategy. In further detail, the strategy selection module 402 may facilitate the classification of the tokens based on a task-specific loss, such as cross-entropy. The strategy selection module 402 may determine a set of model parameters corresponding to a reference language model trained on external data associated with the specific entity or task, for the loss-based grouping strategy. The strategy selection module 402 may compute a first cross-entropy loss value using the model parameters of the pre-trained LLM and a second cross-entropy loss value using the set of model parameters of the reference language model. After that, strategy selection module 402 may compute an excess loss value, for each token, as a difference between the first cross-entropy loss value and the second cross-entropy loss value, using the AI/ML model (for example, loss-based model), from the model database 208. In an aspect, the strategy selection module 402 may compute the excess loss value, for each token, by using the below expression:

$$E ( {w}^{( i , j )} ) := {ℒ}_{C E} ( {w}^{( i , j )} ; θ ) - {ℒ}_{C E} ( {w}^{( i , j )} ; ϕ )$$

wherein,
E(w^{(i,j)}) may denote excess loss value associated with token w_{i,j};
w_{i,j} may denote j-th token in the i-th training sample (for example, sentence or sequence) of the supervised fine-tuning dataset;
φ may denote the set of model parameters of reference model trained on data from the same domain;
θ may denote the model parameters (for example, weights, embeddings, attention parameters, or the like) of the pre-trained LLM;
[symbol] _{CE}(w^{(i,j)}; θ) may denote the first cross-entropy loss value using the model parameters of the pre-trained LLM (θ); and
[symbol] _{CE}(w^{(i,j)}; φ) may denote the second cross-entropy loss value for the token w_{i,j} using the set of model parameters of the reference language model (φ).
   In the further steps, the classification module 406 may group the tokens with the highest excess loss (for example, top-n number of tokens) as important tokens and grouping rest of the tokens as unimportant tokens.

In some examples, the strategy selection module 402, may implement the loss-based grouping strategy, by using the AI/ML model such as, a loss-based model, from the model database 208. The strategy selection module 402, by using the loss-based model may assign token importance based on excess loss, thereby capturing tokens which may exhibit a disproportionately high contribution to the LLM uncertainty. The strategy selection module 402, by using the loss-based model may systematically identify tokens which are inherently difficult for the pre-trained LLM to predict. As a result, as shown in FIG. 4C, strategy selection module 402, by using the loss-based model may preferentially assigns high importance to key domain-specific terms, such as “buns,” “heated,” and “temperature,” while deprioritizing syntactic connectors and predictable function words. The distinction may indicate that the strategy selection module 402, by using the loss-based model may operate as a semantically aligned importance estimator, thereby favoring words that directly impact the pre-trained LLM's learning and downstream task performance.

After implementation of the grouping strategies, the grouping function module 404 may generate the grouping function (may be denoted as g(.)) for the each of the grouping strategy based on the generated preservation probability score and the computed excess loss value. Thereafter, the classification module 406 may assign the importance label to each token in the determined supervised fine-tuning dataset based on the determined grouping function, using the selected grouping strategy. In some examples, the importance label may be a binary label indicating whether the token is important (denoted as “1”) or unimportant (denoted as “0”), expressed as below:

$$g ( {w}^{( i , j )} , {s}^{( i )} ) ∈ \{ 1 , 0 \}$$

The classification module 406, by using the grouping function (g), may determine the importance value of the token w^{(i,j)} within the sentence s⁽ⁱ⁾, considering the role of the token w^{(i,j)} in conveying the semantic meaning.

In further detail, the classification module 406 may compute an importance score for each token by applying the grouping function associated with the selected grouping strategy to the ordered sequence of the tokens. The importance score may include the TF-IDF score and/or a token frequency statistic for the statistics-based grouping strategy, the preservation probability score for the semantics-based grouping strategy, and the excess loss value for the loss-based grouping strategy. Moreover, the classification module 406 may compare the computed importance score with a pre-defined threshold importance score. Subsequently, based on the results of the comparison, the classification module 406 may assign the important token label and/or the unimportant token label to each token in the determined supervised fine-tuning dataset. The classification module 406 may assign the important token label to the tokens, for which the computed importance score exceeds or equals the pre-defined threshold importance score. Also, classification module 406 may assign the unimportant token label to the tokens, for which the computed importance score falls below the pre-defined threshold importance score.

After assigning the important token label and/or the unimportant token label to each token in the determined supervised fine-tuning dataset, the classification module 406 may classify the ordered sequence of the tokens into a first group including the tokens assigned with the important token label and a second group including the tokens assigned with the unimportant token label. For instance, the first group (denoted as “G₁”) and the second group (denoted as “G₀”), may be expressed as below:

$${G}_{1} = \{ {w}^{( i , j )} \vert g ( {w}^{( i , j )} , {s}^{( i )} ) = 1 \}$$

$${G}_{0} = \{ {w}^{( i , j )} \vert g ( {w}^{( i , j )} , {s}^{( i )} ) = 0 \}$$

wherein each token occurrence within a sentence may belong exclusively to one of the groups (that is G₁ or G₀) based on the grouping function g(·).

FIG. 5 illustrates an example block diagram 500 of the loss function module 218 to compute the group-optimization loss value of the tokens of the supervised fine-tuning dataset, in accordance with implementations of the present disclosure. The loss function module 218 may further include a first loss value module 502, a second loss value module 504 and a third loss value module 506. In some examples, the loss function module 218 may be communicatively coupled to the enterprise database 220. The enterprise database 220 may be used to store various data and intermediate results generated by the first loss value module 502, the second loss value module 504 and the third loss value module 506, of the loss function module 218.

The first loss value module 502 may compute the first loss value (denoted as, [symbol] _{CE}(w; θ)) corresponding to the average cross-entropy loss value for the tokens of the supervised fine-tuning dataset. In further detail, the first loss value module 502 may predict a set of probability distributions for each position of the token in the ordered sequence by applying the pre-trained LLM autoregressively to the input sequence. The pre-trained LLM may perform forward pass on the input sequence, by passing the input sequence through the transformer layers of the pre-trained LLM. At each token position “i”, the pre-trained LLM may generate a hidden state vector “h;”. The first loss value module 502 may project the hidden state vector onto the vocabulary space using a linear language modelling head of the pre-trained LLM. Also, for each token position “i”, the first loss value module 502 may transform the raw logits into the probability distribution, using, for example, the softmax function. For instance, the first loss value module 502 may compute exponential value of each raw logit. The first loss value module 502 may further normalize each exponential value of each raw logit, followed by transforming each normalized value into probabilities.

After determining the set of probability distribution, the first loss value module 502 may compute cross-entropy loss values between the predicted set of probability distributions at each token position and a specific-region distribution of a ground-truth subsequent token in the ordered sequence of the tokens. The ground-truth for the subsequent token may be represented as a one-hot encoded vector (a distribution where the target token has a probability of 1 and remaining tokens 0). The first loss value module 502 may compute the loss value for each individual token at position “i” as the negative log of the probability assigned to the correct token. In this way, the first loss value module 502 may penalizes the pre-trained LLM if the pre-trained LLM assigns low probability to the correct subsequent token in the ordered sequence of the tokens. In some examples, the first loss value module 502 may utilize deep learning libraries (for example, PyTorch and TensorFlow).

After that, the first loss value module 502 may generate a total cross-entropy loss value for the supervised fine-tuning dataset by aggregating the cross-entropy loss values for each token position in the ordered sequence of the tokens. Subsequently, the first loss value module 502 may divide the generated total cross-entropy loss value by a total number of token positions where the prediction was required. As a result, the first loss value module 502 may obtain the first loss value as the average cross-entropy loss value based on the generated total cross-entropy loss value and a total number of token positions.

After obtaining the first loss value, the second loss value module 504 may compute the second loss value. In further detail, the second loss value module 504 may identify a first subset of token occurrences assigned with the important token label. The second loss value module 504 retrieve the first subset from the first group (G₁) including the tokens assigned with the important token label (classified by the classification module 406). The second loss value module 504 may further, compute a token-level cross-entropy loss value for each token occurrence in the first subset based on a predicted token probability distribution and a corresponding ground-truth token. Herein, the token-level cross-entropy loss value for each token occurrence may may refer to the value which may measure the discrepancy between the pre-trained LLM's predicted probability distribution and the actual target token, calculated individually at each step of sequence generation. Subsequently, the second loss value module 504 may compute the second loss value as an average cross-entropy loss value for the tokens assigned with the important token label by aggregating the token-level cross-entropy loss value for the first subset.

Additionally, or alternatively, the third loss value module 506 may compute the third loss value. In further detail, the third loss value module 506 may identify a second subset of token occurrences assigned with the unimportant token label. The third loss value module 506 retrieve the second subset from the second group (G₀) including the tokens assigned with the unimportant token label (classified by the classification module 406). The third loss value module 506 may further compute the token-level cross-entropy loss value for each token occurrence in the second subset based on the predicted token probability distribution and the corresponding ground-truth token. Subsequently, the third loss value module 506 may compute the third loss value as an average cross-entropy loss value for the tokens assigned with the unimportant token label by aggregating the token-level cross-entropy losses for the second subset.

Moreover, the loss function module 218 may compute the group-optimization loss value. To compute the group-optimization loss value, the loss function module 218 may first compute a maximum group loss value by selecting a maximum value between the second loss value and the third loss value. Also, the loss function module 218 may compute a current weighting coefficient based on a current training iteration index, a total number of training iterations, an initial weighting factor, and a minimum weighting factor. Subsequently, the loss function module 218 may compute the group-optimization loss value as the weighted combination of the first loss value and the maximum group loss value using the current weighting coefficient. In some examples, the loss function module 218 may utilize the below expression to compute the group-optimization loss value (denoted as [symbol] _{GO}):

$${ℒ}_{G O} ( w ; θ ) = ( 1 - λ ) {ℒ}_{C E} ( w ; θ ) + {λℒ}_{worst} ( w ; g , θ )$$

wherein,
[symbol] _{CE}(w; θ) may denote the standard average cross-entropy loss computed over all tokens w in the supervised fine-tuning training dataset;
[symbol] _{worst}(w; g, θ) may denote the loss computed for low-priority tokens, may be defined as:

$${L}_{w o r s t} ( w ; g , θ ) = max ( {ℒ}_{C E} ( {w}_{{G}_{1}} ; θ ) , {ℒ}_{C E} ( {w}_{{G}_{0}} ; θ ) )$$

wherein, [symbol] _{CE}(w_{G}_{₁}; θ) and [symbol] _{CE}(w_{G}_{₀}; θ) may denote the average cross entropy losses computed over the tokens assigned with the important token label and the tokens assigned with the unimportant token labels, respectively; and
λ may denote the current weighting coefficient. The current weighting coefficient may include a weighting parameter between 0 and 1 which may control the influence of the group-optimization loss value.

The loss function module 218, by implementing the computed group-optimization loss value ( [symbol] _{GO}), may minimize the standard auto regressive loss. Additionally, the loss function module 218 may reduce the maximum loss between the important tokens (referenced as the first group (G₁) including the tokens assigned with the important token label) and unimportant tokens (referenced as the second group (G₀) including the tokens assigned with the unimportant token label). The worst-group loss in the loss function module 218 may penalize the group that the pre-trained model finds most difficult to learn during training. This ensures balanced learning for the pre-trained LLM without overlooking any of the important tokens and the unimportant tokens groups.

Moreover, the loss function module 218 may, during implementation of the computed group-optimization loss value ( [symbol] _{GO}), the coefficient λ may be a constant or a decaying function which may place more emphasis on group optimization during the early stages of training of the pre-trained training, expressed as below:

$$λ = max ( {λ}_{max} ( 1 - t / T ) , {λ}_{min} )$$

where, the loss function module 218 may decay the λ value from λₘₐₓ to λₘᵢₙ during the T training steps. Thereby, the pre-trained LLM may reduce the loss of the unimportant tokens during the initial training phases and gradually shift emphasis back to the standard loss as training progresses.

Below provided expressions may prove that fine-tuning of the pre-trained LLM by utilizing the group-optimization loss value ( [symbol] _{GO}) may facilitate inter-group token balance relative to conventional training approaches. The result of implementing the group-optimization loss value ( [symbol] _{GO}) may be stated in the following proposition 1:

Proposition 1: Let \hat{θ} be the solution obtained by minimizing the group objective function ( [symbol] _{GO}(w; θ)), and let θ_{avg} be the solution obtained by minimizing the standard autoregressive objective function. Then, the worst-group loss of the pre-trained with group optimization is less than that of the pre-trained LLM, trained with the standard objective:

$$ℒ wrt ( \hat{θ} ) \leq ℒ wrt ( {θ}_{a v g} )$$

The above proposition may imply that the pre-trained LLM optimized with the group objective function ( [symbol] _{GO}(w; θ)) achieves better performance on the worst-performing group compared to the pre-trained LLM trained with the above expressed standard objective function.

Proof of the proposition 1: prove without the constant λ in the group objective function ( [symbol] _{GO}(w; θ)). Let θ_{avg}=arg min [symbol] _{C}(θ). By definition of \hat{θ}, following expressions may be obtained:

$${ℒ}_{G} ( w ; \hat{θ} ) = {ℒ}_{C} ( \hat{θ} ) + ℒ wrt θ \leq ℒ C θ avg + ℒ wrt θ avg = ℒ G θ avg$$

$$Suppose , ℒ wrt ( \hat{θ} ) > ℒ wrt ( {θ}_{a v g} )$$

Further, the below expression may be true,

$${ℒ}_{C} ( \hat{θ} ) + ℒ wrt ( \hat{θ} ) \leq {ℒ}_{C} ( {θ}_{a v g} ) + ℒ wrt ( {θ}_{a v g} )$$

$$if {ℒ}_{C} ( \hat{θ} ) < {ℒ}_{C} ( {θ}_{a v g} )$$

However, by definition of θ_{avg}, no other θ can produce a smaller loss than θ_{avg} on the loss [symbol] . Therefore, [symbol] wrt(\hat{θ})> [symbol] wrt(θ_{avg})
is not possible.

Thereafter, the back-end system 106 may examine the convergence rate of the error in stochastic gradient descent towards the global optimum. The back-end system 106 may define the excess error after T iterations as:

$${ε}_{T} := {ℒ}_{G} ( {θ}^{( 1 : T )} ) - {min}_{θ ∈ Θ} {ℒ}_{G} ( θ )$$

where θ^{(1:T)} may represent the average of the parameters over steps 1 to T. The back-end system 106 may demonstrate that minimizing group objective function ( [symbol] _{GO}(w; θ)) converges at the standard rate of O(1/\sqrt{T}). This result may be formally presented in the following proposition 2:

Proposition 2: Let the loss function [symbol] _{G} in the group objective function ( [symbol] _{GO}(w; θ)) is convex and possess Lipschitz continuous sub gradients, and that the parameter space Θ is convex, closed, and bounded such that |θ−θ′|≤B_{θ} for some constant B_{θ} for all θ, θ′∈Θ. Then, the average parameter θ^{(1:T)} obtained over T iterations of supervised fine-tuning may achieve an expected excess error bounded by:

$$E [ {ε}_{T} ] \leq O ( 1 / \sqrt{T} )$$

where the expectation is over the randomness introduced by the sampling in the algorithm. Thus, the resulting proof of proposition 2 may indicate that the implementation of the group objective function ( [symbol] _{GO}(w; θ)) is efficient, achieving convergence at the same rate as standard fine-tuning in convex optimization settings.

Proof of the proposition 2: the following may be assumed:
Θ is convex, closed, and bounded with ∥θ−θ′∥≤B_{θ} for some constant B_{θ} and for all θ, θ′∈Θ;
the loss [symbol] in the group objective function ( [symbol] _{GO}(w; θ)) is convex in θ; and
the loss [symbol] has Lipschitz subgradients (that is, there exists G≥0 such as any subgradient g^{(t)}∈∂F(θ) satisfies ∥g^{(t)}∥≤G.

Further, the subgradient of [symbol] may be denoted at iteration t by g^{(t)} and the Euclidean projection onto Θ by ΠΘ. The parameter update by the algorithm becomes θ₍ₜ₊₁₎=Π_{Θ}[θ^{(t)}−ηg^{(t)}], where η may denote the learning rate.

Also, the solution of L may be denoted by θ* (that is, θ:=arg min [symbol] _{G}(θ)). Considering the excess error,

$${{{{‖ {θ}^{( t + 1 )} - {θ}^{*} ‖}^{2} <= ‖ {θ}^{( t )} - η {g}^{( t )} - {θ}^{*} ‖}^{2} = ‖ {θ}^{( t )} - {θ}^{*} ‖}^{2} - 2 η {g}^{( t )} ( {θ}^{( t )} - {θ}^{*} ) + {η}^{2} ‖ {g}^{( t )} ‖}^{2}$$

rearranging to obtain:

$${g}^{( t )} ( {θ}^{( t )} - {θ}^{*} ) \leq \frac{{‖ {θ}^{( t )} - {θ}^{*} ‖ - ‖ {θ}^{( t + 1 )} - {θ}^{*} ‖}^{2}}{2 η} + \frac{η}{2} {‖ {g}^{( t )} ‖}^{2}$$

As g^{(t)} is a subgradient of the convex function L, [symbol] _{G}(θ^{(t)})− [symbol] _{G}(θ*)≤g^{(t)}(θ^{(t)}−θ*), then the below expression may be obtained:

$${ℒ}_{G} ( {θ}^{( t )} ) - {ℒ}_{G} ( {θ}^{*} ) \leq \frac{{‖ {θ}^{( t )} - {θ}^{*} ‖ - ‖ {θ}^{( t + 1 )} - {θ}^{*} ‖}^{2}}{2 η} + \frac{η}{2} {‖ {g}^{( t )} ‖}^{2}$$

Summing the inequality for T steps as:

$${\sum }_{t = 1}^{T} [ {ℒ}_{G} ( {θ}^{( t )} ) - {ℒ}_{G} ( {θ}^{*} ) ] \leq \frac{1}{2 η} {\sum }_{t = 1}^{T} ( ‖ {θ}^{( t )} - {θ}^{*} ‖ - {‖ {θ}^{( t + 1 )} - {θ}^{*} ‖}^{2} ) + \frac{η}{2} {\sum }_{t = 1}^{T} {‖ {g}^{( t )} ‖}^{2}$$

using telescopic sum, the below may be derived:

$${{{\sum }_{t = 1}^{T} ( ‖ {θ}^{( t )} - {θ}^{*} ‖ - ‖ {θ}^{( t + 1 )} - {θ}^{*} ‖}^{2} ) = ‖ {θ}^{( 1 )} - {θ}^{*} ‖ - ‖ {θ}^{( T + 1 )} - {θ}^{*} ‖}^{2}$$

$${\leq ‖ {θ}^{( 1 )} - {θ}^{*} ‖}^{2}$$

$$\leq {B}_{θ}^{2}$$

$$thus ,$$

$${\sum }_{t = 1}^{T} [ {ℒ}_{G} ( {θ}^{( t )} ) - {ℒ}_{G} ( {θ}^{*} ) ] \leq \frac{{B}_{θ}^{2}}{2 η} + \frac{η}{2} {\sum }_{t = 1}^{T} {‖ {g}^{( t )} ‖}^{2}$$

Due to Lipschitz assumption,

$${{\sum }_{t = 1}^{T} ‖ {g}^{( t )} ‖}^{2} \leq T {G}^{2} .$$

### Therefore,

$${\sum }_{t = 1}^{T} [ {ℒ}_{G} ( {θ}^{( t )} ) - {ℒ}_{G} ( {θ}^{*} ) ] \leq \frac{{B}_{θ}^{2}}{2 η} + \frac{η}{2} T {G}^{2}$$

Choose learning rate η=D/G\sqrt{T} and placing in the above equation, the below expression may be obtained:

$${\sum }_{t = 1}^{T} [ {ℒ}_{G} ( {θ}^{( t )} ) - {ℒ}_{G} ( {θ}^{*} ) ] \leq {B}_{θ} G \sqrt{T}$$

For the average iterate

$$\overline{{θ}^{( 1 : T )}} = {\sum }_{t = 1}^{T} {θ}^{( t )} / T ,$$

Jensen's inequality gives:

$${ℒ}_{G} ( \overline{{θ}^{( 1 : T )}} ) \leq \frac{1}{T} {\sum }_{t = 1}^{T} {ℒ}_{G} ( {θ}^{( t )} )$$

Subtracting [symbol] _{G}(θ*) from the above equation and combining with the above equation (obtained after choosing learning rate η=D/G\sqrt{T}), the below expression may be obtained:

$${ℒ}_{G} ( \overline{{θ}^{( 1 : T )}} ) - {ℒ}_{G} ( {θ}^{*} ) \leq \frac{1}{T} {\sum }_{t = 1}^{T} [ {ℒ}_{G} ( {θ}^{( t )} ) - {ℒ}_{G} ( {θ}^{*} ) ] \leq {B}_{θ} G / \sqrt{T}$$

$$thus , E [ {ε}_{T} ] \leq O ( 1 / \sqrt{T} )$$

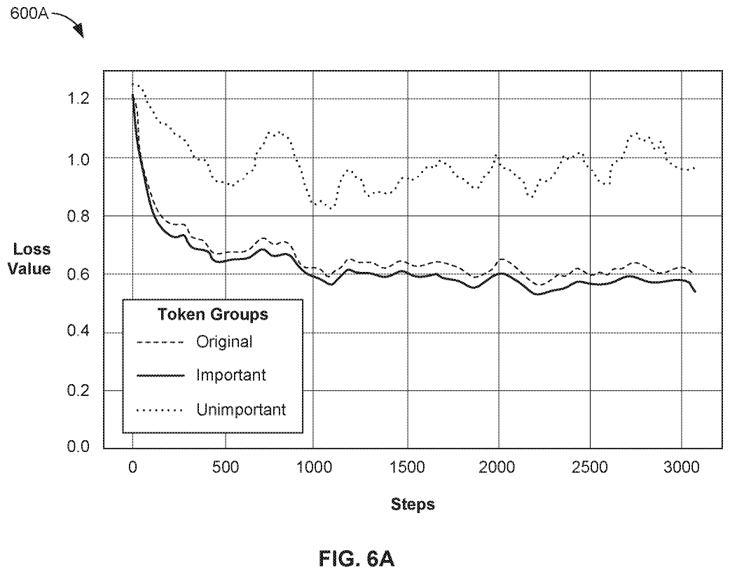

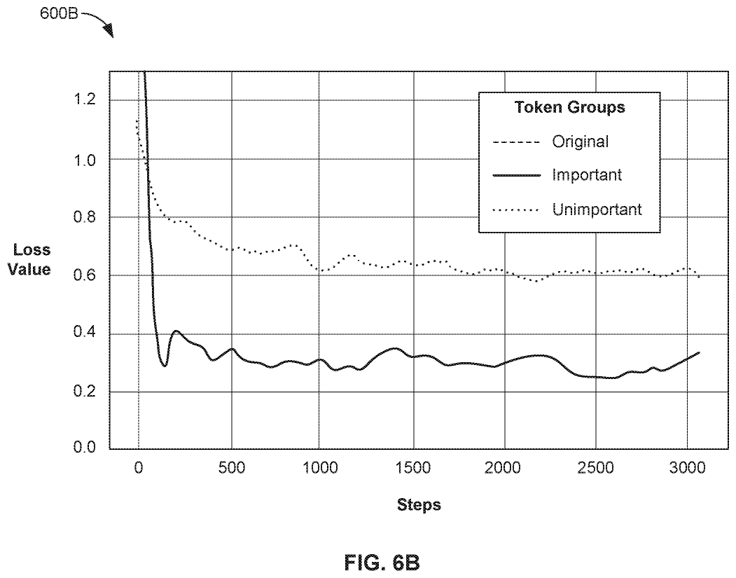

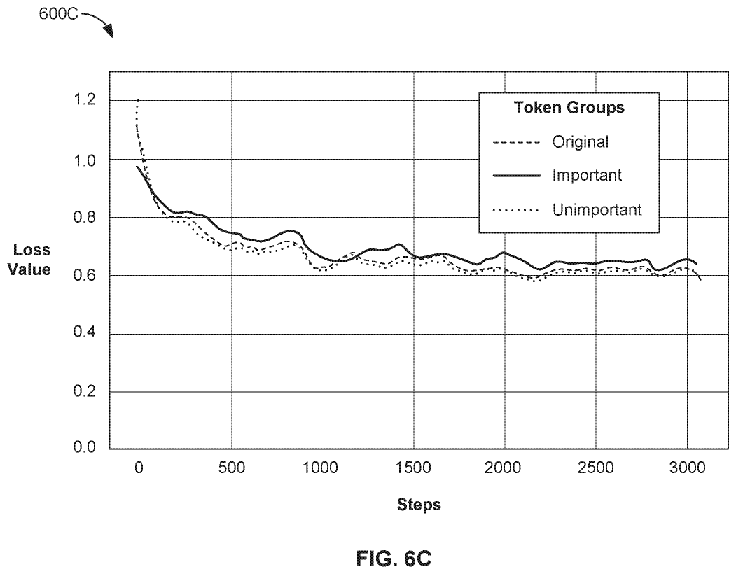

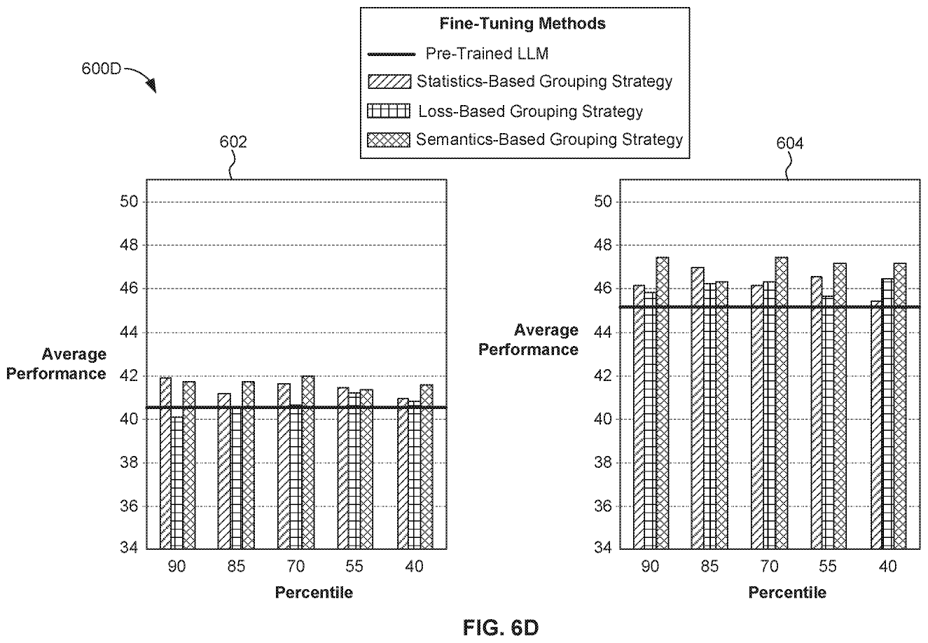

FIG. 6A to 6C illustrates the example charts representing the behavior of different training methods, by selecting grouping strategy, that is, the statistics-based grouping strategy, the semantics-based grouping strategy, and the loss-based grouping strategy, respectively, on important and unimportant tokens by analyzing the training loss curves. FIG. 6A represents the average loss for all tokens in the received supervised fine-tuning dataset, important tokens, and unimportant tokens as selected by the grouping function g, based on the loss-based grouping strategy. FIG. 6A shows that the unimportant token loss (the solid curve) remains consistently high throughout supervised fine-tuning of the pre-trained LLM. The back-end system 106 by utilizing the loss-based grouping strategy may leverage the excess error between the current pre-trained LLM and the reference language model. The consistently high loss may indicate that both the current pre-trained LLM and the reference language model may struggle with the tokens (i.e., both [symbol] _{C}(w; θ) and [symbol] _{C}(w; φ) are high). This indicates that the reference language model may inadequately capture token importance, hindering effective training. By design, the token w may be considered unimportant and is not optimized in the worst-group loss [symbol] wrt if [symbol] _{C}(w; θ)≈ [symbol] _{C}(w; φ).

FIG. 6B represents the average loss for all tokens in the received supervised fine-tuning dataset, important tokens, and unimportant tokens as selected by the grouping function g, based on the statistics-based grouping strategy. FIG. 6B illustrates that the average loss for important tokens (the solid curve) decreases rapidly and plateaus, while the unimportant token loss (the dotted curve) closely mirrors the overall loss. The statistics-based grouping strategy may identify distinctive lexical patterns but struggles with nuanced semantic relationships. As the important token loss decreases below the unimportant token loss, the worst-group loss ( [symbol] wrt) targets the unimportant token loss. Consequently, after initial training, the optimization process resembles standard training without group-based adjustments.

FIG. 6C represents the average loss for all tokens in the received supervised fine-tuning dataset, important tokens, and unimportant tokens as selected by the grouping function g, based on the semantics-based grouping strategy. The loss between important tokens (i.e., the solid curve) and unimportant tokens (the dotted curve) is relatively small, and both curves closely follow the average loss of all tokens (the dashed curve). This behavior indicates that the worst group loss [symbol] wrt, shifts between the two groups throughout training, focusing on the worst groups as the model progresses. This occurs because the grouping function defined by the semantic-based strategy, may identify important tokens by considering the semantics of each token within the context of the document in which the tokens appear.

FIG. 6D illustrates example plots representing average performance across the first subset of criteria (including the subject-specific criteria) and the second subset of criteria (including the general reasoning criteria) for the pre-trained LLM trained using different fine-tuning methods under varying partition thresholds. In particular, FIG. 6D presents comparative results for an example first pre-trained LLM 602 configuration and a second pre-trained LLM 604 configuration, each fine-tuned on the supervised fine-tuning dataset.

In the illustrated examples, the horizontal axis may represent percentile-based partition thresholds, including thresholds such as 90, 85, 70, 55, and 40, while the vertical axis may represent average performance aggregated across one or more benchmarks. Each group of bars may correspond to a respective fine-tuning method, including the pre-trained LLM fine-tuning method, the statistics-based grouping strategy, the semantics-based grouping strategy, and the loss-based grouping strategy, applied to models of different parameter scales.

As shown, for partition thresholds between approximately the 90th percentile and the 55th percentile, the average performance values attain relatively higher levels across both model configurations. Within this range, models trained using the group optimization loss value using the iterative gradient-based optimization model, including the statistics-based grouping strategy, the semantics-based grouping strategy, and the loss-based grouping strategy, may exhibit higher average performance than pre-trained LLM, across the evaluated benchmarks.

In this context, a partition threshold such as the 90th percentile may indicates that a lower portion of tokens (for example, the bottom 90 percent ranked according to the grouping function) may be categorized as unimportant tokens, while a higher portion of tokens (for example, the top 10 percent) may be categorized as important tokens for training and evaluation. Accordingly, FIG. 6D illustrates the relationship between token-level partitioning criteria and resulting model performance under different fine-tuning strategies.

Moreover, in some examples, the pre-defined threshold importance score (let be, denoted as η, where η∈(0,1)), may be used to determine whether the token is important within a document for each grouping function g. A higher n value may result in more tokens being classified as unimportant, thereby serving as the partition threshold. FIG. 6D may illustrate the average performance across the one or more benchmarks for different partition thresholds, fine-tuned the pre-trained LLM (such as, LIMA). In both plots, the bars attain the highest values when the compression rate is between 90% and 55%. Across said range, the fine-tuned LLMs, obtained by updating the set of model parameters of the pre-trained LLM based on the group optimization loss value, consistently outperform the received pre-trained LLMs, thereby highlighting the robustness of supervised fine-tuning.

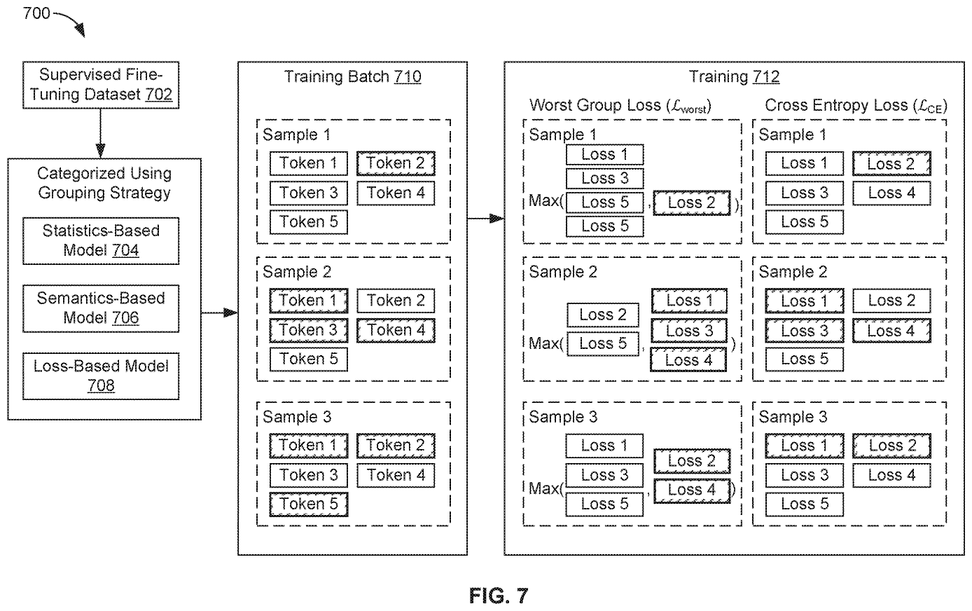

FIG. 7 illustrates an example block diagram illustrating the fine-tuning process of the LLMs based on the group optimization loss value using the iterative gradient-based optimization model. In this example, a supervised fine-tuning dataset 702 is categorized according to one or more grouping strategies, which may include, but are not limited to: (i) the statistics-based grouping strategy, (ii) the semantics-based grouping strategy, and (iii) the loss-based grouping strategy. The statistics-based grouping strategy may be implemented by a statistics-based model 704, the semantics-based grouping strategy may be implemented by a semantics-based model 706, and the loss-based grouping strategy may be implemented by a loss-based model 708. Based on outputs of one or more of the models 704-708, one or more grouping functions may assign tokens to groups. A training batch 710 may then be formed from training samples of the supervised fine-tuning dataset 702 and may categorize tokens into the important token group (referenced as the first group (G₁) including the tokens assigned with the important token label) and the unimportant token group (referenced as the second group (G₀) including the tokens assigned with the unimportant token label), based on the grouping functions. As shown in the FIG. 7, the training samples may be represented as “sample 1”, “sample 2” and “sample 3”. Additionally, “token 1”, “token 2”, “token 3”, “token 4” and “token 5” may represent individual tokens corresponding to individual training samples. The shaded tokens in each sample may represent unimportant-token group and unshaded tokens in sample may represent important-token group. Loss may be computed per token.

During training 712, loss value corresponding to the average cross-entropy loss value ( [symbol] _{C}) for the tokens of the supervised fine-tuning dataset 702 (for example, across a current training batch 710). In parallel, respective group losses for the important-token group and the unimportant-token group may be determined, and the worst-group loss ( [symbol] wrt) may be derived from the maximum loss value between the important token groups and the unimportant token groups. As shown in the figure, “loss 1”, “loss 2”, “loss 3”, “loss 4” and “loss 5” may represent per-token loss values. The LLM may then be updated based on the group-optimization loss (for example, an objective that incorporates the standard cross-entropy loss and the worst-group loss), such that iterative gradient-based updates reduce overall prediction error while mitigating disproportionate error on the worst-group loss group of tokens.

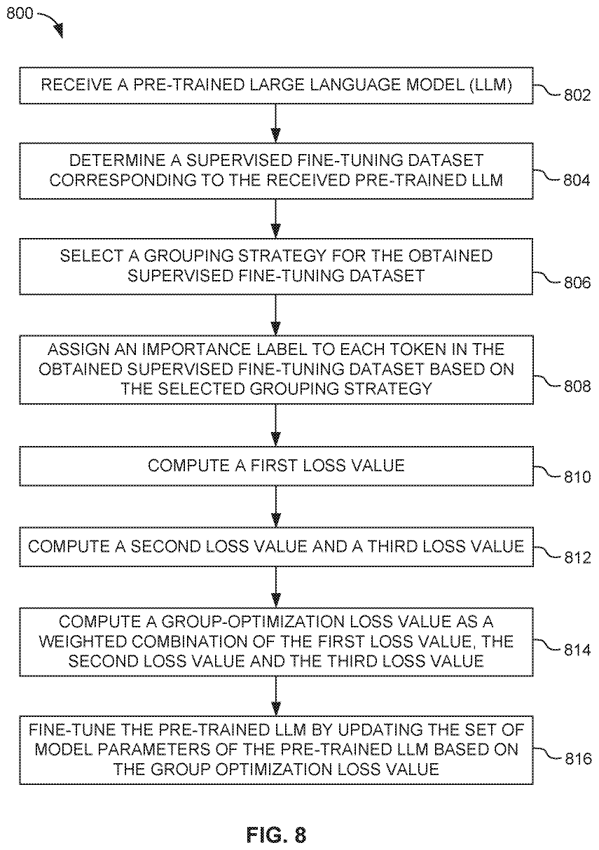

FIG. 8 illustrates a flow diagram of an example method 800 for fine-tuning of Large Language Models, executed by the back-end system 106, in accordance with implementations of the present disclosure. In some examples, the method 800 may be executed using the one or more processors 204 disclosed in related to FIGS. 1-7.

The method 800 may include receiving 802 a pre-trained Large Language Model (LLM) with a set of model parameters from a data source.

Further, the method 800 may include determining 804 a supervised fine-tuning dataset corresponding to the received pre-trained LLM from the data source. Herein, the supervised fine-tuning dataset may include training samples with each training sample including an input sequence and a corresponding output sequence. Each output sequence may include an ordered sequence of tokens. In further detail, the obtaining 704 the supervised fine-tuning dataset, may further include receiving candidate prompt-response pairs from community data source and/or synthetic data source. Thereafter, a subset of quality prompt-response pairs, may be generated, by filtering the received candidate prompt-response pairs based on a quality criteria. The subset of the quality prompt-response pairs may include a subset of community-sourced pairs and a subset of user defined pairs. Additionally, or alternatively, a second subset of instruction-response pairs, may be generated, using one or more LLMs based on template prompts and task descriptions. The second subset of the instruction-response pairs may include synthetic data samples and raw data samples. Moreover, a tokenized representation of the candidate prompt-response pairs, may be generated, by normalizing a corresponding input sequence and a corresponding output sequence for each prompt-response pair in the subset of the quality prompt-response pairs and the second subset of the instruction-response pairs. The corresponding output sequence, may also be generated, as the ordered sequence of the tokens based on the generated tokenized representation. Furthermore, one or more training samples, may be generated, by assigning the corresponding ordered sequence of the tokens as a training target. Subsequently, the one or more training samples, may be aggregated, from the first subset and the second subset into the supervised fine-tuning dataset. Each training sample may include the input sequence and the corresponding output sequence with the ordered sequence of tokens.

The method 800 may include selecting 806 a grouping strategy for the determined supervised fine-tuning dataset. The grouping strategy may include, but not limited to, a statistics-based grouping strategy, a semantics-based grouping strategy, and a loss-based grouping strategy. In further detail, a user input may be received for the determined supervised fine-tuning dataset from a user 104. Unigram term-frequency-inverse-document-frequency (TF-IDF) scores, may precomputed for the tokens in the supervised fine-tuning dataset. The TF-IDF scores may indicate a rarity level of each token corresponding to the supervised fine-tuning dataset. Furthermore, a preservation probability score for each token in the supervised fine-tuning dataset, may be generated by encoding the ordered sequence of the tokens in the input sequence. The preservation probability score may indicate a decision of retaining the token in a compressed representation of the input sequence. Also, a set of model parameters corresponding to a reference language model trained on an external data for the loss-based grouping strategy may be determined. After that, a first cross-entropy loss value, may be computed, using the model parameters of the pre-trained LLM and a second cross-entropy loss value using the set of model parameters of the reference language model. An excess loss value, for each token, as a difference between the first cross-entropy loss value and the second cross-entropy loss value may also be computed. Subsequently, a grouping function for the each of the grouping strategy, may be generated, based on the generated preservation probability score and the computed excess loss value.

The method 800 may include assigning 808 an importance label to each token in the determined supervised fine-tuning dataset based on the selected grouping strategy. The importance label may include, but not limited to, an important token label and an unimportant token label. In further detail, an importance score for each token, may be computed, by applying the grouping function associated with the selected grouping strategy to the ordered sequence of the tokens. Herein, the importance score may include, but not limited to, a TF-IDF score, a token frequency statistic for the statistics-based grouping strategy, the preservation probability score for the semantics-based grouping strategy, and the excess loss value for the loss-based grouping strategy. Thereafter, the important token label and/or the unimportant token label, may be assigned to each token in the determined supervised fine-tuning dataset by comparing the computed importance score with a threshold importance score. Subsequently, the ordered sequence of the tokens may be classified into a first group comprising the tokens assigned with the important token label and a second group comprising the tokens assigned with the unimportant token label.

Moreover, the method 800 may include computing 810 a first loss value corresponding to an average cross-entropy loss value for the tokens of the supervised fine-tuning dataset using the pre-trained large LLM and based on the assigned importance label. In further detail, a set of probability distributions, may be predicted for each position of the token in the ordered sequence by applying the pre-trained LLM autoregressively to the input sequence. Further, cross-entropy loss values between the predicted set of probability distributions, may be computed at each token position and a specific-region distribution of a ground-truth subsequent token in the ordered sequence of the tokens. After that, a total cross-entropy loss value for the supervised fine-tuning dataset may be generated, by aggregating the cross-entropy loss values for each token position in the ordered sequence of the tokens. Subsequently, the first loss value may be obtained as the average cross-entropy loss value based on the generated total cross-entropy loss value and a total number of token positions.

The method 800 may include computing 812 a second loss value and a third loss value corresponding to an average cross-entropy loss value for each of the tokens assigned with the important token label and the tokens assigned with the unimportant token labels using the pre-trained large LLM. In further detail, a first subset of token occurrences assigned with the important token label and a second subset of token occurrences assigned with the unimportant token label may be identified. Moreover, a token-level cross-entropy loss value for each token occurrence in the first subset and the second subset, may be computed, based on a predicted token probability distribution and a corresponding ground-truth token. Additionally, or alternatively, the second loss value may be computed as an average cross-entropy loss value for the tokens assigned with the important token label by aggregating the token-level cross-entropy loss value for the first subset. Subsequently, the third loss value may be computed as an average cross-entropy loss value for the tokens assigned with the unimportant token label by aggregating the token-level cross-entropy losses for the second subset.

The method 800 may include computing 814 a group-optimization loss value as a weighted combination of the first loss value, the second loss value and the third loss value. In further detail, a maximum group loss value may be computed by selecting a maximum value between the second loss value and the third loss value. After that, a current weighting coefficient may be computed based on a current training iteration index, a total number of training iterations, an initial weighting factor, and a minimum weighting factor. Subsequently, the group-optimization loss value may be computed as the weighted combination of the first loss value and the maximum group loss value using the current weighting coefficient.

Consequently, the method 800 may include fine-tuning 816 the pre-trained LLM by updating the set of model parameters of the pre-trained LLM based on the group optimization loss value using an iterative gradient-based optimization model. In further detail, trajectories of the first loss value, the second loss value, and the third loss value, may be determined, as functions of a training iteration index for each of the statistics-based grouping strategy, the semantics-based grouping strategy, and the loss-based grouping strategy during the training iterations. The determined trajectories may be mapped as time series data for each grouping strategy. The time series data may indicate a behavior of the cross-entropy loss value for the tokens assigned with the important token label, and the tokens assigned with the unimportant token label. Furthermore, gradients for the group-optimization loss value may be computed based on the set of model parameters of the pre-trained LLM using a backpropagation network with subsequent-token predictions. Subsequently, the set of model parameters of the pre-trained LLM may be updated based on the computed gradients and the mapped time series data by applying the iterative gradient-based optimization model, with a learning rate, a cosine decay learning rate schedule, and an epsilon parameter, for training iterations until a termination condition being satisfied.

Implementations of the present disclosure provide technical advancements in the context of fine-tuning of Large Language Models. For instance, the present disclosure may exhibit flexibility in defining token groups based on various notions of importance. The present disclosure, by utilizing the group optimization as a general instruction fine tuning framework, may achieve performance gains without relying on task-specific fine-tuned reference models. In the present disclosure, instead of treating each data input as a unit, the tokens within each data sample may be analyzed and groupings may be performed among said tokens. By applying the [symbol] wrt penalty, the system forces the gradient signal to prioritize Important Tokens (G₁) that the model finds difficult, thereby ensuring that critical domain knowledge (like chemical formulas or code logic) is learned rather than bypassed.

Furthermore, in the present disclosure, the back-end system may the group the tokens within each data sample, into important token group (that is, the first group comprising the tokens assigned with the important token label) and unimportant token group (that is, the second group comprising the tokens assigned with the unimportant token label). Moreover, the present disclosure may include computing loss value for important and unimportant tokens separately.

Additionally, in the present disclosure, the implementation of the decaying λ parameter allows the pre-trained LLM to shift the focus throughout the training lifecycle. The pre-trained LLM may correct “worst-case” performance in the early stages (exploration) and gradually shift toward stabilizing global performance in the later stages (exploitation), thereby resulting in stable convergence.

Moreover, in the present disclosure, treating loss as the time-series data point rather than a scalar may enable users (such as, developers) to detect gradient interference early, thereby enabling the users to halt training or adjust hyperparameters before the model parameters diverge.

Further, in the present disclosure, may implement subject-specific criteria (such as, Massive Multitask Language Understanding (MMLU), MathQA, AI2 Reasoning Challenge (ARC-C) and OpenBookQA) and general reasoning criteria (such as, Harder Endings, Longer contexts, and Low-shot Activities for Situations with Adversarial Generations (HellaSwag), Truthful Question Answering (TruthfulQA) and Instruction-Following Evaluation (IFEval)), for evaluating the performance of the fine-tuned LLM. Technically, the multi-faceted evaluation may prevent metric hacking and identifies catastrophic forgetting by ensuring that gains in specialized subject matter do not degrade fundamental reasoning. Furthermore, integrating TruthfulQA and IFEval may add a layer of operational reliability, thereby measuring the fine-tuned LLM's resistance to hallucinations and corresponding strict adherence to complex formatting constraints. Aggregating the average scores may enable users to optimize the fine-tuned LLM along with balancing specialized expert performance and the general-purpose stability required for safe, real-world deployment.

In essence, the present disclosure discloses supervised fine-tuning with group-optimization. The present disclosure may enhance LLMs by focusing on different token groups via corresponding importance to model training. The present disclosure groups tokens based on the importance and optimized the model using a weighted combination of the standard cross-entropy and the worst-group loss. The present disclosure may demonstrate the effectiveness of the determined fine-tuned LLM on different groups and the efficiency of the convergence rate. In the present disclosure, empirical evaluations across multiple token grouping strategies may confirm the effectiveness in outperforming the traditional fine-tuning of LLMs.

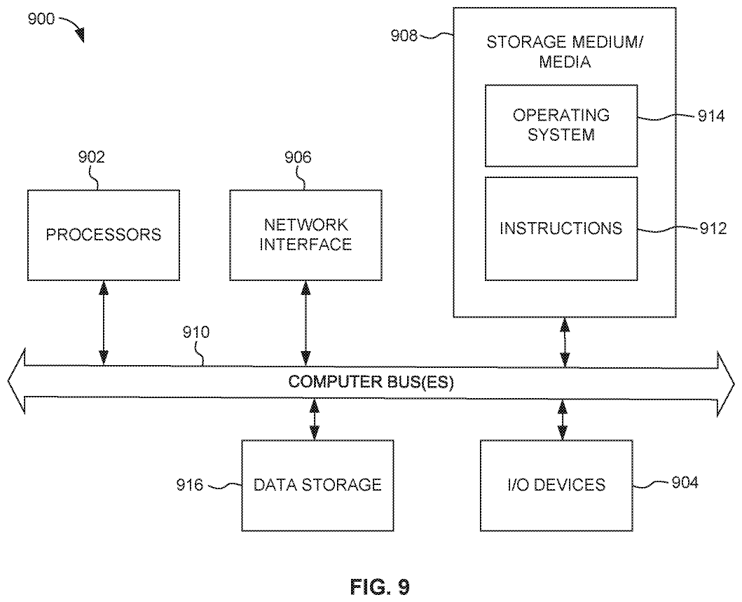

FIG. 9 illustrates a computer system 900 that may be used to implement the back-end system 106 disclosed in the example environment of FIG. 1. for fine-tuning of the LLMs, in accordance with implementations of the present disclosure. More particularly, computing machines such as desktops, laptops, smartphones, tablets, and wearables which may be used to implement the tasks that may have the structure of the computer system 900. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 502.11x LAN, a 3G or 4G mobile WAN or a WiMax WAN, and a computer-readable medium 908. Each of these components may be operatively coupled to a bus 410. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the methods and functions of the system for fine-tuning of the LLMs.

The system 106 may be implemented as software stored on a non-transitory processor-readable medium and executed by the processors 902. For example, the computer-readable medium 908 may store an operating system 914, such as MAC OS, MS WINDOWS, UNIX, or LINUX, and code for the system. The operating system 914 may be multi-user, multiprocessing, multitasking, multithreading, real-time, and the like. For example, during runtime, the operating system 914 is running and the code for the system is executed by the processor(s) 902.

The computer system 900 may include a data storage 916, which may include non-volatile data storage. The data storage 916 stores any data used or generated by the system.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (for example, a field programmable gate array (FPGA) or an application specific integrated circuit (ASIC)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a pre-trained Large Language Model (LLM) with a set of model parameters from at least one data source;
determine a supervised fine-tuning dataset corresponding to the received pre-trained LLM from the at least one data source, wherein the supervised fine-tuning dataset comprises a plurality of training samples with each training sample comprising an input sequence and a corresponding output sequence, wherein each of the input sequence and the output sequence comprises an ordered sequence of tokens;
select a grouping strategy for the determined supervised fine-tuning dataset, wherein the grouping strategy comprises at least one of a statistics-based grouping strategy, a semantics-based grouping strategy, and a loss-based grouping strategy;
assign an importance label to each token in the determined supervised fine-tuning dataset based on the selected grouping strategy, wherein the importance label comprises one of an important token label and an unimportant token label;
compute a first loss value corresponding to an average cross-entropy loss value for the tokens of the supervised fine-tuning dataset using the pre-trained large LLM and based on the assigned importance label;
compute a second loss value and a third loss value corresponding to an average cross-entropy loss value for each of the tokens assigned with the important token label and the tokens assigned with the unimportant token labels using the pre-trained large LLM, respectively;
compute a group-optimization loss value as a weighted combination of the first loss value, the second loss value and the third loss value; and
fine-tune the pre-trained LLM by updating the set of model parameters of the pre-trained LLM based on the group optimization loss value using an iterative gradient-based optimization model.

2. The system of claim 1, wherein to determine the supervised fine-tuning dataset corresponding to the received pre-trained LLM, the processor is to:
receive a plurality of candidate prompt-response pairs from at least one community data source and at least one synthetic data source;
generate a subset of quality prompt-response pairs by filtering the received plurality of candidate prompt-response pairs based on a quality criteria, wherein the subset of the quality prompt-response pairs comprise a subset of community-sourced pairs and a subset of user defined pairs;
generate a subset of instruction-response pairs using a plurality of LLMs based on template prompts and task descriptions, associated with the pre-trained LLM, wherein the subset of the instruction-response pairs comprises synthetic data samples and raw data samples, of the supervised fine-tuning dataset;
generate a tokenized representation of the plurality of candidate prompt-response pairs by normalizing a corresponding input sequence and a corresponding output sequence for each prompt-response pair in the subset of the quality prompt-response pairs and the subset of the instruction-response pairs;
generate the corresponding output sequence as the ordered sequence of the tokens based on the generated tokenized representation;
generate the plurality of training samples by assigning the corresponding ordered sequence of the tokens as a training target; and
aggregate the plurality of training samples from the subset of quality prompt-response pairs and the subset of instruction-response pairs,
into the supervised fine-tuning dataset, wherein each training sample comprises the input sequence and the corresponding output sequence with the ordered sequence of tokens.

3. The system of claim 1, wherein to select the grouping strategy for the determined supervised fine-tuning dataset, the processor is to:
receive a user input for the determined supervised fine-tuning dataset from a user; and
precompute unigram term-frequency-inverse-document-frequency (TF-IDF) scores for the tokens in the supervised fine-tuning dataset, wherein the TF-IDF scores indicate a rarity level of each token corresponding to the supervised fine-tuning dataset.

4. The system of claim 3, wherein to select the grouping strategy for the determined supervised fine-tuning dataset, the processor is to:
generate a preservation probability score for each token in the supervised fine-tuning dataset by encoding the ordered sequence of the tokens in the input sequence, wherein the preservation probability score indicates a decision of retaining the token in a compressed representation of the input sequence;
determine a set of model parameters corresponding to a reference language model trained on an external data for the loss-based grouping strategy;
compute a first cross-entropy loss value using the plurality of model parameters of the pre-trained LLM and a second cross-entropy loss value using the set of model parameters of the reference language model;
compute an excess loss value, for each token, as a difference between the first cross-entropy loss value and the second cross-entropy loss value; and
generate a grouping function for each of the statistics-based grouping strategy, a semantics-based grouping strategy, and a loss-based grouping strategy based on the generated preservation probability score and the computed excess loss value.

5. The system of claim 1, wherein to assign the importance label to each token in the determined supervised fine-tuning dataset based on the selected grouping strategy, the processor is to:
compute an importance score for each token by applying the grouping function associated with the selected grouping strategy to the ordered sequence of the tokens, wherein the importance score comprises at least one of a TF-IDF score, a token frequency statistic for the statistics-based grouping strategy, the preservation probability score for the semantics-based grouping strategy, and the excess loss value for the loss-based grouping strategy;
assign at least one of the important token label and the unimportant token label to each token in the determined supervised fine-tuning dataset by comparing the computed importance score with a threshold importance score; and
classify the ordered sequence of the tokens into a first group comprising the tokens assigned with the important token label and a second group comprising the tokens assigned with the unimportant token label.

6. The system of claim 1, wherein to compute the first loss value corresponding to the average cross-entropy loss value for the tokens of the supervised fine-tuning dataset using the pre-trained large LLM and based on the assigned importance label, the processor is to:
predict a set of probability distributions for each position of the token in the ordered sequence by applying the pre-trained LLM autoregressively to the input sequence;
compute a plurality of cross-entropy loss values between the predicted set of probability distributions at each token position and a specific-region distribution of a ground-truth subsequent token in the ordered sequence of the tokens;
generate a total cross-entropy loss value for the supervised fine-tuning dataset by aggregating the plurality of cross-entropy loss values for each token position in the ordered sequence of the tokens; and
obtain the first loss value as an average cross-entropy loss value based on the generated total cross-entropy loss value and a total number of token positions.

7. The system of claim 1, wherein to compute the second loss value and the third loss value corresponding to the average cross-entropy loss value for each of the tokens assigned with the important token label and the tokens assigned with the unimportant token labels using the pre-trained large LLM, the processor is to:
identify a first subset of token occurrences assigned with the important token label and a second subset of token occurrences assigned with the unimportant token label;
compute a token-level cross-entropy loss value for each token occurrence in the first subset and the second subset based on a predicted token probability distribution and a corresponding ground-truth token;
compute the second loss value as an average cross-entropy loss value for the tokens assigned with the important token label by aggregating the token-level cross-entropy loss value for the first subset; and
compute the third loss value as an average cross-entropy loss value for the tokens assigned with the unimportant token label by aggregating the token-level cross-entropy losses for the second subset.

8. The system of claim 1, wherein to compute the group-optimization loss value as the weighted combination of the first loss value, the second loss value and the third loss value, the processor is to:
compute a maximum group loss value by selecting a maximum value between the second loss value and the third loss value;
compute a current weighting coefficient based on a current training iteration index, a total number of training iterations, an initial weighting factor, and a minimum weighting factor; and
compute the group-optimization loss value as the weighted combination of the first loss value and the maximum group loss value using the current weighting coefficient.

9. The system of claim 1, wherein to fine-tune the pre-trained LLM by updating the set of model parameters of the pre-trained LLM based on the group optimization loss value using the iterative gradient-based optimization model, the processor is to:
determine trajectories of the first loss value, the second loss value, and the third loss value as functions of a training iteration index for each of the statistics-based grouping strategy, the semantics-based grouping strategy, and the loss-based grouping strategy during the plurality of training iterations;
map the determined trajectories as time series data for each grouping strategy, wherein the time series data indicates a behavior of the cross-entropy loss value for the tokens assigned with the important token label, and the tokens assigned with the unimportant token label;
compute a plurality of gradients for the group-optimization loss value based on the set of model parameters of the pre-trained LLM using a backpropagation network with subsequent-token predictions; and
update the set of model parameters of the pre-trained LLM based on the computed plurality of gradients and the mapped time series data by applying the iterative gradient-based optimization model, with a learning rate, a cosine decay learning rate schedule, and an epsilon parameter, for the plurality of training iterations until a termination condition being satisfied.

10. The system of claim 1, wherein the processor is to:
evaluate the fine-tuned LLM on a first subset of criteria, wherein the first subset of criteria comprise subject-specific criteria, wherein the subject-specific criteria comprise a plurality of benchmarks evaluating subject-specific accuracy and the density of specialized latent knowledge within the parameters of the fine-tuned LLM;
evaluate the fine-tuned LLM on a second subset of criteria, wherein the second subset of criteria comprises general reasoning criteria, wherein the general reasoning criteria comprise a plurality of benchmarks evaluating the fine-tuned LLM's capacity for at least one of logical inference, common sense, and multi-step problem solving; and
compute a first average score for the subject-specific criteria and a second average score for the general reasoning criteria.

11. A method comprising:
receiving, by a processor, a pre-trained Large Language Model (LLM) with a set of model parameters from at least one data source;
determining, by the processor, a supervised fine-tuning dataset corresponding to the received pre-trained LLM from the at least one data source, wherein the supervised fine-tuning dataset comprises a plurality of training samples with each training sample comprising an input sequence and a corresponding output sequence, wherein each of the input sequence and output sequence comprises an ordered sequence of tokens;
selecting, by the processor, a grouping strategy for the determined supervised fine-tuning dataset, wherein the grouping strategy comprises at least one of a statistics-based grouping strategy, a semantics-based grouping strategy, and a loss-based grouping strategy;
assigning, by the processor, an importance label to each token in the determined supervised fine-tuning dataset based on the selected grouping strategy, wherein the importance label comprises one of an important token label and an unimportant token label;
computing, by the processor, a first loss value corresponding to an average cross-entropy loss value for the tokens of the supervised fine-tuning dataset using the pre-trained large LLM and based on the assigned importance label;
computing, by the processor, a second loss value and a third loss value corresponding to an average cross-entropy loss value for each of the tokens assigned with the important token label and the tokens assigned with the unimportant token labels using the pre-trained large LLM, respectively;
computing, by the processor, a group-optimization loss value as a weighted combination of the first loss value, the second loss value and the third loss value; and
fine-tuning, by the processor, the pre-trained LLM by updating the set of model parameters of the pre-trained LLM based on the group optimization loss value using an iterative gradient-based optimization model.

12. The method of claim 11, wherein determining the supervised fine-tuning dataset corresponding to the received pre-trained LLM comprises:
receiving, by the processor, a plurality of candidate prompt-response pairs from at least one community data source and at least one synthetic data source;
generating, by the processor, a subset of quality prompt-response pairs by filtering the received plurality of candidate prompt-response pairs based on a quality criteria, wherein the subset of the quality prompt-response pairs comprise a subset of community-sourced pairs and a subset of user defined pairs;
generating, by the processor, a subset of instruction-response pairs using a plurality of LLMs based on template prompts and task descriptions, associated with the pre-trained LLM, wherein the subset of the instruction-response pairs comprise synthetic data samples and raw data samples, of the supervised fine-tuning dataset;
generating, by the processor, a tokenized representation of the plurality of candidate prompt-response pairs by normalizing a corresponding input sequence and a corresponding output sequence for each prompt-response pair in the subset of the quality prompt-response pairs and the subset of the instruction-response pairs;
generating, by the processor, the corresponding output sequence as the ordered sequence of the tokens based on the generated tokenized representation;
generating, by the processor, the plurality of training samples by assigning the corresponding ordered sequence of the tokens as a training target; and
aggregating, by the processor, the plurality of training samples from the subset of prompt-response pairs and the subset of instruction-response pairs into the supervised fine-tuning dataset, wherein each training sample comprises the input sequence and the corresponding output sequence with the ordered sequence of tokens.

13. The method of claim 11, wherein selecting the grouping strategy for the determined supervised fine-tuning dataset comprises:
receiving, by the processor, a user input for the determined supervised fine-tuning dataset from a user; and
precomputing, by the processor, unigram term-frequency-inverse-document-frequency (TF-IDF) scores for the tokens in the supervised fine-tuning dataset, wherein the TF-IDF scores indicate a rarity level of each token corresponding to the supervised fine-tuning dataset.

14. The method of claim 13, wherein selecting the grouping strategy for the determined supervised fine-tuning dataset comprises:
generating, by the processor, a preservation probability score for each token in the supervised fine-tuning dataset by encoding the ordered sequence of the tokens in the input sequence, wherein the preservation probability score indicates a decision of retaining the token in a compressed representation of the input sequence;
determining, by the processor, a set of model parameters corresponding to a reference language model trained on an external data for the loss-based grouping strategy;
computing, by the processor, a first cross-entropy loss value using the plurality of model parameters of the pre-trained LLM and a second cross-entropy loss value using the set of model parameters of the reference language model;
computing, by the processor, an excess loss value, for each token, as a difference between the first cross-entropy loss value and the second cross-entropy loss value; and
generating, by the processor, a grouping function for each of the statistics-based grouping strategy, a semantics-based grouping strategy, and a loss-based grouping strategy, based on the generated preservation probability score and the computed excess loss value.

15. The method of claim 11, wherein assigning the importance label to each token in the determined supervised fine-tuning dataset based on the selected grouping strategy comprises:
computing, by the processor, an importance score for each token by applying the grouping function associated with the selected grouping strategy to the ordered sequence of the tokens, wherein the importance score comprises at least one of a TF-IDF score, a token frequency statistic for the statistics-based grouping strategy, the preservation probability score for the semantics-based grouping strategy, and the excess loss value for the loss-based grouping strategy;
assigning, by the processor, at least one of the important token label and the unimportant token label to each token in the determined supervised fine-tuning dataset by comparing the computed importance score with a threshold importance score; and
classifying, by the processor, the ordered sequence of the tokens into a first group comprising the tokens assigned with the important token label and a second group comprising the tokens assigned with the unimportant token label.

16. The method of claim 11, wherein computing the first loss value corresponding to the average cross-entropy loss value for the tokens of the supervised fine-tuning dataset using the pre-trained large LLM and based on the assigned importance label comprises:
predicting, by the processor, a set of probability distributions for each position of the token in the ordered sequence by applying the pre-trained LLM autoregressively to the input sequence;
computing, by the processor, a plurality of cross-entropy loss values between the predicted set of probability distributions at each token position and a specific-region distribution of a ground-truth subsequent token in the ordered sequence of the tokens;
generating, by the processor, a total cross-entropy loss value for the supervised fine-tuning dataset by aggregating the plurality of cross-entropy loss values for each token position in the ordered sequence of the tokens; and
obtaining, by the processor, the first loss value an average cross-entropy loss value based on the generated total cross-entropy loss value and a total number of token positions.

17. The method of claim 11, wherein computing the second loss value and the third loss value corresponding to the average cross-entropy loss value for each of the tokens assigned with the important token label and the tokens assigned with the unimportant token labels using the pre-trained large LLM comprises:
identifying, by the processor, a first subset of token occurrences assigned with the important token label and a second subset of token occurrences assigned with the unimportant token label;
computing, by the processor, a token-level cross-entropy loss value for each token occurrence in the first subset and the second subset based on a predicted token probability distribution and a corresponding ground-truth token;
computing, by the processor, the second loss value as an average cross-entropy loss value for the tokens assigned with the important token label by aggregating the token-level cross-entropy loss value for the first subset; and
computing, by the processor, the third loss value as an average cross-entropy loss value for the tokens assigned with the unimportant token label by aggregating the token-level cross-entropy losses for the second subset.

18. The method of claim 11, wherein computing the group-optimization loss value as the weighted combination of the first loss value, the second loss value and the third loss value comprises:
computing, by the processor, a maximum group loss value by selecting a maximum value between the second loss value and the third loss value;
computing, by the processor, a current weighting coefficient based on a current training iteration index, a total number of training iterations, an initial weighting factor, and a minimum weighting factor; and
computing, by the processor, the group-optimization loss value as the weighted combination of the first loss value and the maximum group loss value using the current weighting coefficient.

19. The method of claim 11, wherein fine-tuning the pre-trained LLM by updating the set of model parameters of the pre-trained LLM based on the group optimization loss value using the iterative gradient-based optimization model comprises:
determining, by the processor, trajectories of the first loss value, the second loss value, and the third loss value as functions of a training iteration index for each of the statistics-based grouping strategy, the semantics-based grouping strategy, and the loss-based grouping strategy during the plurality of training iterations;
mapping, by the processor, the determined trajectories as time series data for each grouping strategy, wherein the time series data indicates a behavior of the cross-entropy loss value for the tokens assigned with the important token label, and the tokens assigned with the unimportant token label;
computing, by the processor, a plurality of gradients for the group-optimization loss value based on the set of model parameters of the pre-trained LLM using a backpropagation network with subsequent-token predictions; and
updating, by the processor, the set of model parameters of the pre-trained LLM based on the computed plurality of gradients and the mapped time series data by applying the iterative gradient-based optimization model, with a learning rate, a cosine decay learning rate schedule, and an epsilon parameter, for the plurality of training iterations until a termination condition being satisfied.

20. A non-transitory computer readable medium comprising a processor-executable instructions that cause a processor to:
receive a pre-trained Large Language Model (LLM) with a set of model parameters from at least one data source;
determine a supervised fine-tuning dataset corresponding to the received pre-trained LLM from the at least one data source, wherein the supervised fine-tuning dataset comprises a plurality of training samples with each training sample comprising an input sequence and a corresponding output sequence, wherein each of the input sequence and the output sequence comprises an ordered sequence of tokens;
select a grouping strategy for the determined supervised fine-tuning dataset, wherein the grouping strategy comprises at least one of a statistics-based grouping strategy, a semantics-based grouping strategy, and a loss-based grouping strategy;
assign an importance label to each token in the determined supervised fine-tuning dataset based on the selected grouping strategy, wherein the importance label comprises one of an important token label and an unimportant token label;
compute a first loss value corresponding to an average cross-entropy loss value for the tokens of the supervised fine-tuning dataset using the pre-trained large LLM and based on the assigned importance label;
compute a second loss value and a third loss value corresponding to an average cross-entropy loss value for each of the tokens assigned with the important token label and the tokens assigned with the unimportant token labels using the pre-trained large LLM, respectively;
compute a group-optimization loss value as a weighted combination of the first loss value, the second loss value and the third loss value; and
fine-tune the pre-trained LLM by updating the set of model parameters of the pre-trained LLM based on the group optimization loss value using an iterative gradient-based optimization model.
